(19) United States
(12) Patent Application Publication
(10) Pub. No.: US 2017/0238751 A1
(43) Pub. Date: Aug. 24, 2017

(54) WIRELESSLY CONTROLLED COOKING SYSTEM

(71) Applicant: Meyer Intellectual Properties Limited, Kowloon (HK)

(72) Inventor: Darren Erik Vengroff, Seattle, WA (US)

(73) Assignee: Meyer Intellectual Properties Limited, Kowloon (HK)

(21) Appl. No.: 15/434,695

(22) Filed: Feb. 16, 2017

Related U.S. Application Data
(60) Provisional application No. 62/297,134, filed on Feb. 18, 2016.
(60) Provisional application No. 62/302,018, filed on Mar. 1, 2016.

(51) Int. Cl. A47J 27/62; F24C 15/10; G05B 13/04; H05B 1/02; F24C 7/08; G06F 3/01

(52) U.S. Cl. CPC A47J 27/62; F24C 7/082; F24C 7/087; G06F 3/01; G05B 13/041; G05B 13/042; H05B 1/0266; F24C 15/105; H05B 2213/06

(57) ABSTRACT

According to one example, a system includes a heat source operable to provide an amount of energy to be used to cook a food item. The system further includes a processor operable to establish a first communication link with a wireless device having a cooking recipe for the food item. The processor is further operable to receive, via the first communication link, an indication of a first temperature associated with the cooking recipe. The processor is further operable to establish a second communication link with a cooking device system operable to be used in cooking the food item, and to receive, via the second communication link, an indication of a current temperature associated with the food item. The processor is further operable to, based on the indication of the first temperature and the indication of the current temperature, adjust the amount of energy provided by the heat source.

### CROSS-REFERENCE TO RELATED APPLICATIONS

This application claims priority to U.S. Provisional Patent Application No. 62/297,134 filed Feb. 18, 2016, and further claims priority to U.S. Provisional Patent Application No. 62/302,018 filed Mar. 1, 2016, the entirety of both of which are incorporated herein by reference.

### TECHNICAL FIELD

This disclosure relates generally to the field of cooking appliances and more specifically to a user interface for a cooking system.

### BACKGROUND

Traditionally, a user has cooked food by manually turning on a heat source using a knob, placing the food over the heat source, and estimating (or measuring or timing) when the food is done cooking. Such traditional cooking techniques, however, may be deficient.

### SUMMARY

A first aspect of the invention is achieved by a system comprising: a wireless device having a processor that is operable, when executed, to: display at least a portion of a cooking recipe; and establish a first communication link with a heat source system to be used to cook a food item in accordance with the cooking recipe; the heat source system, comprising: a heat source operable to provide an amount of energy to be used to cook the food item in accordance with the cooking recipe; and a processor communicatively coupled to the heat source, and operable, when executed, to: establish a second communication link with a cooking device system; receive, via the first communication link with the wireless device, an indication of a first temperature associated with the cooking recipe; receive, via the second communication link with the cooking device system, an indication of a current temperature associated with the food item; and based on the indication of the first temperature and the indication of the current temperature, adjust the amount of energy provided by the heat source; and the cooking device system, comprising: a cooking device operable to be used in cooking the food item in accordance with the cooking recipe; one or more temperature sensors coupled to the cooking device and operable to provide a measurement of the current temperature associated with the food item; and a processor communicatively coupled to the one or more temperature sensors, and operable, when executed, to communicate the indication of the current temperature associated with the food item for reception by the heat source system via the second communication link.

Another aspect of the invention is any such system wherein the processor of the heat source system is further operable, when executed, to: receive, via the first communication link with the wireless device, an indication of a duration of time associated with the first temperature; determine whether the first communication link with the wireless device has failed; and in response to the determination that the first communication link with the wireless device has failed: determine whether the duration of time associated with the first temperature has lapsed; in response to the determination that the duration of time associated with the first temperature has not lapsed, continue to allow the heat source to provide the adjusted amount of energy.

Another aspect of the invention is any such system wherein the processor of the heat source system is further operable, when executed, to: receive, via the first communication link with the wireless device, an indication of a hold temperature; and in response to the determination that the duration of time associated with the first temperature has lapsed, further adjust the amount of energy provided by the heat source based on the hold temperature.

Another aspect of the invention is any such system wherein the processor of the wireless device is further operable, when executed, to: establish a third communication link with the cooking device system; receive, via the third communication link with the cooking device system, the indication of the current temperature associated with the food item; and display a graphical representation of the current temperature associated with the food item.

A second aspect of the invention is achieved by a system comprising a heat source operable to provide an amount of energy to be used to cook a food item; and a processor communicatively coupled to the heat source, and operable, when executed, to: establish a first communication link with a wireless device having a cooking recipe for the food item; receive, via the first communication link with the wireless device, an indication of a first temperature associated with the cooking recipe; establish a second communication link with a cooking device system operable to be used in cooking the food item; receive, via the second communication link with the cooking device system, an indication of a current temperature associated with the food item; and based on the indication of the first temperature and the indication of the current temperature, adjust the amount of energy provided by the heat source.

Another aspect of the invention is any such system wherein the processor is further operable, when executed, to: receive, via the first communication link with the wireless device, an indication of a duration of time associated with the first temperature; determine whether the first communication link with the wireless device has failed; and in response to the determination that the first communication link with the wireless device has failed: determine whether the duration of time associated with the first temperature has lapsed; in response to the determination that the duration of time associated with the first temperature has not lapsed, continue to allow the heat source to provide the adjusted amount of energy.

Another aspect of the invention is any such system wherein the processor is further operable, when executed, to: receive, via the first communication link with the wireless device, an indication of a hold temperature; and in response to the determination that the duration of time associated with the first temperature has lapsed, further adjust the amount of energy provided by the heat source based on the hold temperature.

Another aspect of the invention is any such system wherein the processor is further operable, when executed, to: in further response to the determination that the first communication link with the wireless device has failed, scan through one or more additional communication protocols in order to attempt to reestablish the first communication link.

Another aspect of the invention is any such system wherein the processor is further operable, when executed, to: receive, via the first communication link with the wireless device, an indication of a duration of time associated with the first temperature; receive, via the first communication link with the wireless device, an indication of a second temperature associated with the cooking recipe; receive, via the second communication link with the cooking device system, an indication of a subsequent current temperature associated with the food item; determine whether the duration of time associated with the first temperature has lapsed; and in response to the determination that the duration of time associated with the first temperature has lapsed, further adjust the amount of energy provided by the heat source based on the indication of the second temperature and the indication of the subsequent current temperature.

Another aspect of the invention is any such system wherein the processor is further operable, when executed, to: receive, via the second communication link with the cooking device system, an advertisement packet from the cooking device system; following the reception of the advertisement packet, transmit, via the second communication link with the cooking device system, a request for additional information from the cooking device system; and following the transmittal of the request for additional information, receive, via the second communication link with the cooking device system, a scan response packet from the cooking device system, wherein the scan response packet includes the indication of the current temperature associated with the food item.

Another aspect of the invention is any such system wherein the processor is further operable, when executed, to: receive, via the first communication link with the wireless device, a unique identifier for the cooking device system; and establish the second communication link with the cooking device system based on the unique identifier for the cooking device system received from the wireless device.

Another aspect of the invention is any such system wherein the cooking device system comprises a cooking device, wherein the cooking device is a cooking pot, a cooking pan, a cooking tray, or a cooking utensil.

A third aspect of the invention is achieved by a method comprising: establishing, by a processor communicatively coupled to a heat source, a first communication link with a wireless device having a cooking recipe for a food item, wherein the heat source is operable to provide an amount of energy to be used to cook the food item; receiving, by the processor and via the first communication link with the wireless device, an indication of a first temperature associated with the cooking recipe; establishing, by the processor, a second communication link with a cooking device system operable to be used in cooking the food item; receiving, by the processor and via the second communication link with the cooking device system, an indication of a current temperature associated with the food item; and based on the indication of the first temperature and the indication of the current temperature, adjusting, by the processor, the amount of energy provided by the heat source.

Another aspect of the invention is any such method, further comprising: receiving, by the processor and via the first communication link with the wireless device, an indication of a duration of time associated with the first temperature; determining, by the processor, whether the first communication link with the wireless device has failed; and in response to the determination that the first communication link with the wireless device has failed: determining, by the processor, whether the duration of time associated with the first temperature has lapsed; and in response to the determination that the duration of time associated with the first temperature has not lapsed, continuing, by the processor, to allow the heat source to provide the adjusted amount of energy.

Another aspect of the invention is any such method, further comprising: receiving, by the processor and via the first communication link with the wireless device, an indication of a hold temperature; and in response to the determination that the duration of time associated with the first temperature has lapsed, further adjusting, by the processor, the amount of energy provided by the heat source based on the hold temperature.

Another aspect of the invention is any such method, further comprising: in further response to the determination that the first communication link with the wireless device has failed, scanning, by the processor, through one or more additional communication protocols in order to attempt to reestablish the first communication link.

Another aspect of the invention is any such method, further comprising: receiving, by the processor and via the first communication link with the wireless device, an indication of a duration of time associated with the first temperature; receiving, by the processor and via the first communication link with the wireless device, an indication of a second temperature associated with the cooking recipe; receiving, by the processor and via the second communication link with the cooking device system, an indication of a subsequent current temperature associated with the food item; determining, by the processor, whether the duration of time associated with the first temperature has lapsed; and in response to the determination that the duration of time associated with the first temperature has lapsed, further adjusting, by the processor, the amount of energy provided by the heat source based on the indication of the second temperature and the indication of the subsequent current temperature.

Another aspect of the invention is any such method, further comprising: receiving, by the processor and via the second communication link with the cooking device system, an advertisement packet from the cooking device system; following the reception of the advertisement packet, transmitting, by the processor and via the second communication link with the cooking device system, a request for additional information from the cooking device system; and following the transmittal of the request for additional information, receiving, by the processor and via the second communication link with the cooking device system, a scan response packet from the cooking device system, wherein the scan response packet includes the indication of the current temperature associated with the food item.

Another aspect of the invention is any such method, further comprising: receiving, by the processor and via the first communication link with the wireless device, a unique identifier for the cooking device system; and establishing, by the processor, the second communication link with the cooking device system based on the unique identifier for the cooking device system received from the wireless device.

Another aspect of the invention is any such method, wherein the cooking device system comprises a cooking device, wherein the cooking device is a cooking pot, a cooking pan, a cooking tray, or a cooking utensil.

A fourth aspect of the invention is achieved by a system comprising a processor that is operable, when executed, to: display at least a portion of a cooking recipe; establish a first communication link with a heat source system to be used to cook a food item in accordance with the cooking recipe; transmit, via the first communication link, one or more cooking instructions to the heat source system, wherein the one or more cooking instructions are configured to cause the heat source system to adjust an amount of energy provided by a heat source of the heat source system to cook the food item; establish a second communication link with a cooking device system, the cooking device system having a cooking device operable to be used in cooking the food item in accordance with the cooking recipe, and further having one or more temperature sensors coupled to the cooking device and operable to provide a measurement of a current temperature associated with the food item; receive a unique identifier associated with the cooking device system via the second communication link, or a unique identifier associated with the heat source system via the first communication link; and transmit the unique identifier associated with the cooking device system to the heat source system via the first communication link, or the unique identifier associated with the heat source system to the cooking device system via the second communication link; and wherein the heat source system is operable to establish a third communication link with the cooking device system using the unique identifier associated with the cooking device system, or wherein the cooking device system is operable to establish the third communication link with the heat source system using the unique identifier associated with the heat source system.

Another aspect of the invention is any such system, wherein the processor is further operable, when executed, to: determine whether the first communication link with the heat source system has failed; and in response to the determination that the first communication link with the heat source system has failed, scan through one or more additional communication protocols in order to attempt to reestablish the first communication link.

A fifth aspect of the invention is achieved by a system comprising: a cooking device operable to be used in cooking a food item in accordance with a cooking recipe; one or more temperature sensors coupled to the cooking device and operable to provide a measurement of the current temperature associated with the food item; and a processor communicatively coupled to the one or more temperature sensors, and operable, when executed, to: establish a first communication link with a wireless device that is operable to display at least a portion of the cooking recipe; establish a second communication link with a heat source system having a heat source operable to provide an amount of energy to be used to cook the food item in accordance with the cooking recipe; and transmit, via the second communication link, an indication of the current temperature associated with the food item for reception by the heat source system, wherein the indication of the current temperature is configured to cause the heat source system to adjust an amount of energy provided by the heat source of the heat source system to the food item when the current temperature associated with the food item is different from a temperature included in the cooking recipe.

Another aspect of the invention is any such system, wherein the processor is further operable, when executed, to: insert the indication of the current temperature associated with the food item into a scan response packet; and transmit the scan response packet for reception by the heat source system.

Another aspect of the invention is any such system, wherein the processor is further operable, when executed, to transmit, via the first communication link, the indication of the current temperature associated with the food item for reception by the wireless device.

A sixth aspect of the invention is achieved by a method comprising providing a cooking system that includes a portable electronic cookbook, a cooking device system, and a heat source system. The heat source system is operative to modulate the energy applied to the cooking device system in response to a measurement of temperature associated with the environment of the cooking device system. The method may further include forming a first communication link with the electronic cookbook and the cooking device system, forming a second communication link with the electronic cookbook and heating source system, and using the first link first link to communicate a unique identifier of the cooking device system from the electronic cookbook to the heat source system and/or using the second link to communicate a unique identifier of the heat source system from the electronic cookbook to the cooking support system. The method may also include forming a third communication link between the cooking device system and the heating source system initiated upon a request from the electronic cookbook after it has communicated the heat source system to the cooking device system or the cooking device system and the heat source system, using the second communication link to instruct the heat source system to receive temperature measurements from the cooking device system via the third communication link, and instructing the heat source system to maintain the cooking device system at a time and temperature schedule having a one or more steps where the temperature is held at a first value for a first duration time, wherein the heat source system is operative modulate the power output to reach and control the temperature of cooking device system at the first value during the first duration.

A seventh aspect of the invention is achieved by a system comprising a wireless device having a processor that is operable, when executed, to: display at least a portion of a cooking recipe; establish a first communication link with a heat source system to be used to cook a food item in accordance with the cooking recipe. The heat source system may comprise a heat source operable to provide an amount of energy to be used to cook the food item in accordance with the cooking recipe; a processor communicatively coupled to the heat source, and operable, when executed, to: establish a second communication link with a cooking device system; receive, via the first communication link with the wireless device, an indication of a first temperature associated with the cooking recipe; receive an indication of a current temperature associated with the food item; and based on the indication of the first temperature and the indication of the current temperature, adjust the amount of energy provided by the heat source. The cooking device system may comprise a cooking device operable to be used in cooking the food item in accordance with the cooking recipe; one or more temperature sensors coupled to the cooking device and operable to provide a measurement of the current temperature associated with the food item; and a processor communicatively coupled to the one or more temperature sensors, and operable, when executed, to communicate the indication of the current temperature associated with the food item for reception by the heat source system via the second communication link.

An eighth aspect of the invention is achieved by a system comprising a processor that is operable, when executed, to: display at least a portion of a cooking recipe; establish a first communication link with a heat source system to be used to cook a food item in accordance with the cooking recipe; and transmit one or more cooking instructions to the heat source system using the first communication link, wherein the one or more cooking instructions are configured to cause the heat source system to adjust an amount of energy provided by a heat source of the heat source system to the food item.

Another aspect of the invention is any such system, wherein the processor is further operable, when executed, to: determine whether the first communication link with the heat source system has failed; and in response to the determination that the first communication link with the heat source system has failed, scan through one or more additional communication protocols in order to attempt to reestablish the first communication link.

A ninth aspect of the invention is achieved by a system comprising a heat source operable to provide an amount of energy to be used to cook a food item; a processor communicatively coupled to the heat source, and operable, when executed, to: establish a first communication link with a wireless device having a cooking recipe for the food item; receive, via the first communication link with the wireless device, an indication of a first temperature associated with the cooking recipe; establish a second communication link with a cooking device system operable to be used in cooking the food item; receive, via the second communication link, an indication of a current temperature associated with the food item; and based on the indication of the first temperature and the indication of the current temperature, adjust the amount of energy provided by the heat source.

Another aspect of the invention is any such system, wherein the processor is further operable, when executed, to: receive, via the first communication link with the wireless device, an indication of a duration of time associated with the first temperature; determine whether the first communication link with the wireless device has failed; and in response to the determination that the first communication link with the wireless device has failed: determine whether the duration of time associated with the first temperature has lapsed; and in response to the determination that the duration of time associated with the first temperature has not lapsed, continue to allow the heat source to provide the amount of energy based on the first temperature.

Another aspect of the invention is any such system, wherein the processor is further operable, when executed, to: receive, via the first communication link with the wireless device, an indication of a hold temperature; and in response to the determination that the duration of time associated with the first temperature has lapsed, adjust the amount of energy provided by the heat source based on the hold temperature.

Another aspect of the invention is any such system, wherein the processor is further operable, when executed, to: in further response to the determination that the first communication link with the wireless device has failed, scan through one or more additional communication protocols in order to attempt to reestablish the first communication link.

A tenth aspect of the invention is achieved by a system comprising a cooking device operable to be used in cooking a food item in accordance with a cooking recipe; one or more temperature sensors coupled to the cooking device and operable to provide a measurement of the current temperature associated with the food item; and a processor communicatively coupled to the one or more temperature sensors, and operable, when executed, to communicate an indication of the current temperature associated with the food item for reception by a heat source system, wherein the indication of the current temperature is configured to cause the heat source system to adjust an amount of energy provided by a heat source of the heat source system to the food item when the current temperature is different from a temperature included in the cooking recipe.

Another aspect of the invention is any such system, wherein the processor is further operable, when executed, to: insert the indication of the current temperature associated with the food item into a scan response packet; and transmit the scan response packet for reception by the heat source system.

Another aspect of the invention is any such system, wherein the processor is further operable, when executed, to insert the indication of the current temperature associated with the food item into a manufacturer-specific advertising data field of the scan response packet.

Another aspect of the invention is any such system, wherein the processor is further operable, when executed to: insert an indication of a subsequent current temperature associated with the food item into a subsequent scan response packet, wherein the indication of the subsequent current temperature associated with the food is different than the indication of the current temperature associated with the food; and transmit the subsequent scan response packet for reception by the heat source system.

Another aspect of the invention is any such system, wherein the processor is further operable, when executed, to transmit, via the first communication link, the indication of the current temperature associated with the food item for reception by the wireless device.

Another aspect of the invention is any such system, wherein the cooking device is a cooking pot, a cooking pan, a cooking tray, or a cooking utensil.

Another aspect of the invention is any such system, wherein the cooking device is a spoon, tongs, a spatula, or a measurement probe.

Another aspect of the invention is any such system, wherein the processor is positioned on or in a handle of the cooking device.

Another aspect of the invention is any such system, further comprising one or more additional sensors coupled to the cooking device and operable to provide a measurement of current additional information associated with the food item, wherein the current additional information comprises the current volume associated with the food item, the current weight associated with the food item, the current moisture associated with the food item, the current liquid level associated with the food item, or the current pressure associated with the food item.

Another aspect of the invention is any such system, wherein the processor is further operable, when executed, to: insert the indication of the current temperature associated with the food item into a scan response packet; insert an indication of the current additional information associated with the food item into the scan response packet; and transmit the scan response packet for reception by the heat source system.

Another aspect of the invention is any such system, wherein the processor is further operable, when executed, to transmit, via the first communication link, an indication of the current additional information associated with the food item for reception by the wireless device.

Another aspect of the invention is any such system, wherein the scan response packet is a WPAN scan response packet.

### BRIEF DESCRIPTION OF THE FIGURES

For a more complete understanding of the present disclosure and its features and advantages, reference is now made to the following description, taken in conjunction with the accompanying drawings, in which:

FIGS. 1A-1B illustrate an example cooking system that may assist a user in cooking a food item;

FIGS. 2-8 illustrate example screenshots displayed by an electronic cookbook on a device; and

FIGS. 9A-9C illustrate an example heat source system having a user interface system.

### DETAILED DESCRIPTION

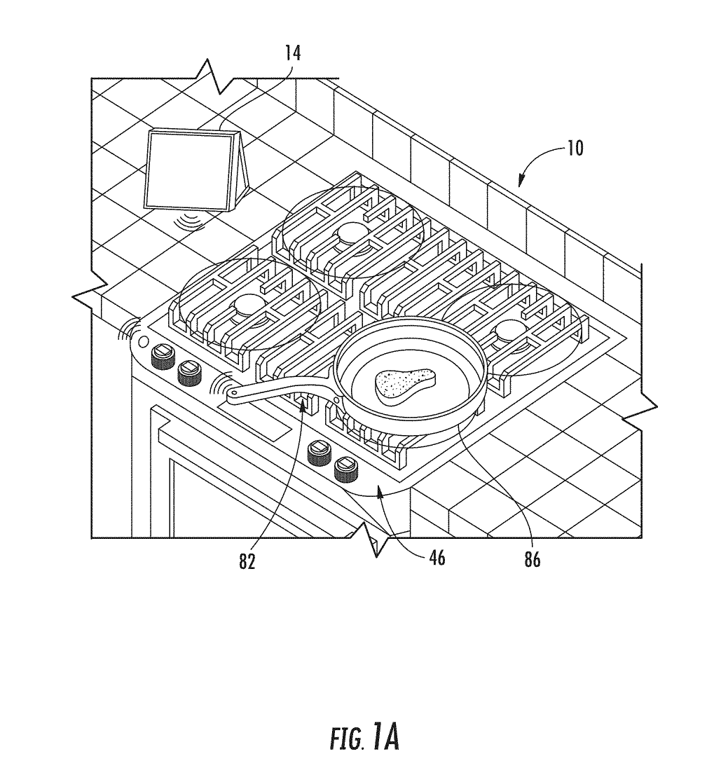

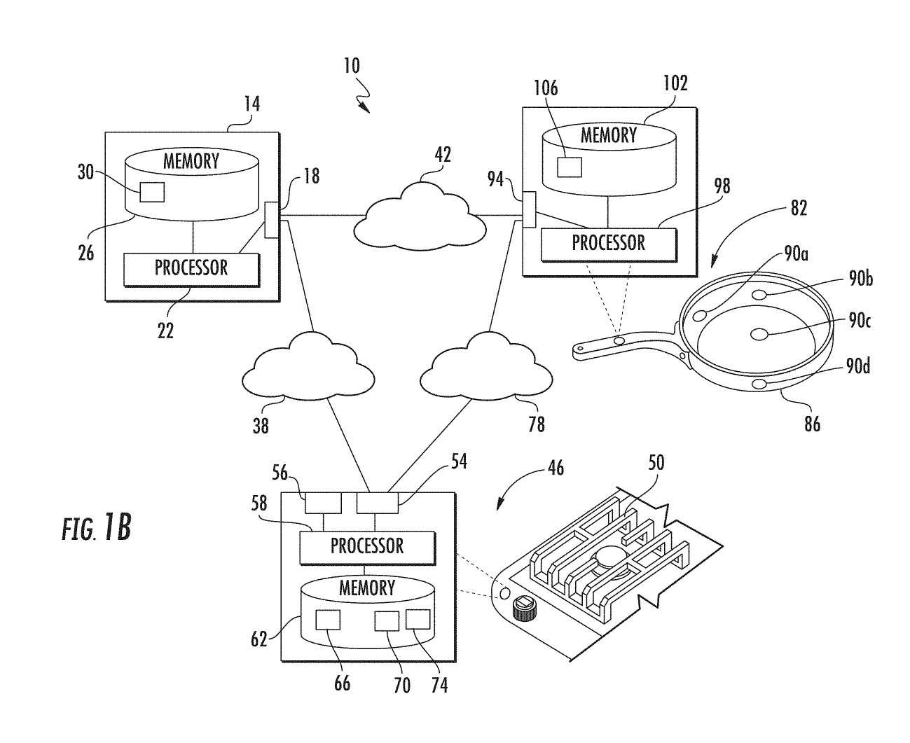

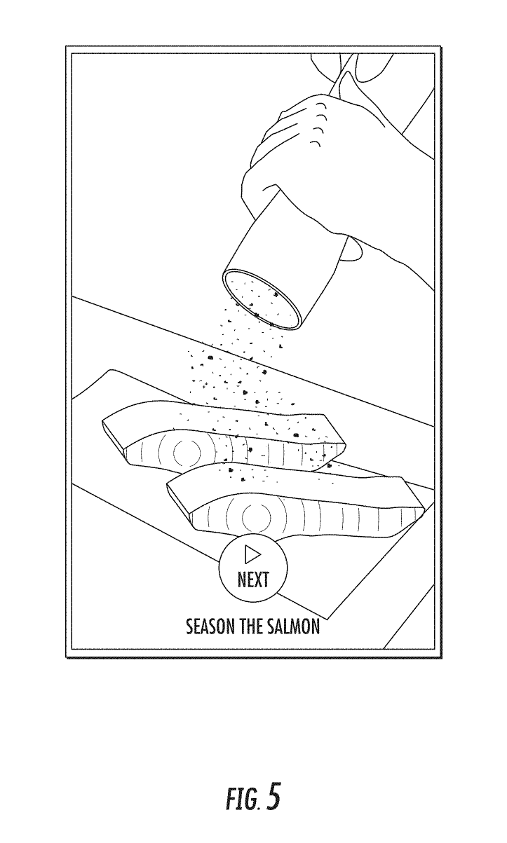

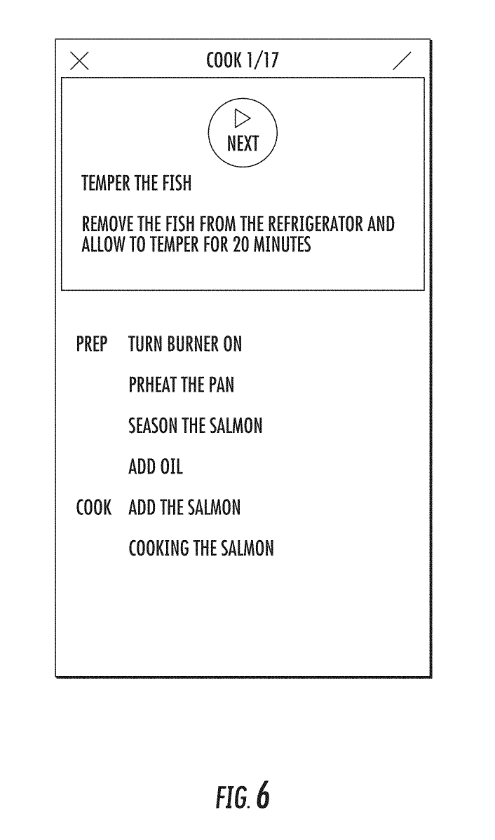

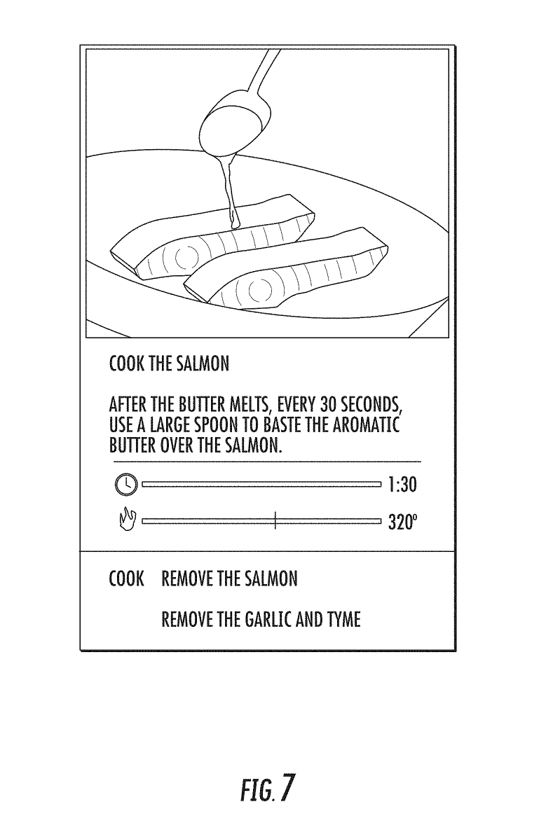

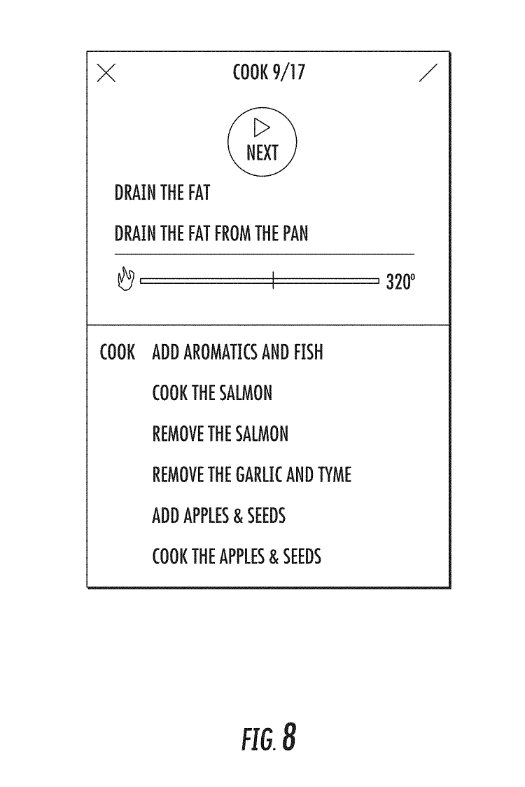

Embodiments of the present disclosure are best understood by referring to FIGS. 1A-9C of the drawings, like numerals being used for like and corresponding parts of the various drawings.

FIGS. 1A-1B illustrate an example cooking system 10 that may assist a user in cooking a food item (such as a steak or chili). As is illustrated, the cooking system 10 includes a wireless device 14 (such as a mobile phone or tablet) that may execute an electronic cookbook 30. Additionally, the cooking system 10 includes a heat source system 46 (such as a gas burner system, an electric burner system or an induction burner system) and a cooking device system (such as a cooking pan or pot) to be used in cooking the food item.

In one example of operation of FIGS. 1A-1B, a user may desire to cook a food item, such as a steak or chili. To do so, the user may utilize their wireless device 14 (such as their mobile phone or tablet) to select a particular recipe for the food item displayed by the electronic cookbook 30 on the wireless device 14. Based on the selection, the wireless device 14 may establish a first communication link (such as a Bluetooth communication link or a Wi-Fi communication link) with the heat source system 46 (such as a stove top) to be used in cooking the food item. In one embodiment, the first communication link with the heat source system 46 may be a wired connection, e.g., via a USB or serial connection.

The wireless device 14 may use this communication link to transmit cooking instructions 70 to the heat source system 46. The cooking instructions 70 may include a particular temperature (such as 375° F.) and a particular duration of time (such as 10 minutes). These cooking instructions 70 may cause the heat source 50 (such as the front left gas burner of the stove top) of the heat source system 46 to begin providing energy to the cooking device 86 (such as a 5 quart pot) of the cooking device system 82. For example, the cooking instructions 70 may cause the heat source 50 to provide a flame (or other source of energy) having an intensity that varies over time so as to raise the temperature of the cooking device 86 to the desired cooking temperature (such as 375° F.) and then maintain that particular temperature (such as 375° F.) for the duration of the cooking process. Furthermore, the cooking instructions 70 may further cause the heat source 50 to provide such a flame for the particular duration of time (such as 10 minutes), adjusting the intensity of the flame using control algorithms to maintain the desired cooking temperature throughout the process.

In addition to the first communication link between the wireless device 14 and the heat source system 46, the heat source system 46 may establish a second communication link (such as a second Bluetooth communication link or a second Wi-Fi communication link) with the cooking device system 82. The cooking device system 82 may utilize the second communication link to transmit measurement information 74 to the heat source system 46. For example, the cooking device system 82 may measure a current temperature associated with the food item, and may communicate this current temperature to the heat source system 46 as the measurement information 74. Based on the measurement information 74, the heat source system 46 may make one or more changes or adjustments to the amount of energy provided by the heat source 50. For example, if the measurement information 74 indicates that the current cooking temperature is below the intended temperature of 375° F., the heat source system 46 may increase the amount of energy provided by the heat source 50. As another example, if the measurement information 74 indicates that the current cooking temperature is above the intended temperature of 375° F., the heat source system 46 may decrease the amount of energy provided by heat source 50. As a further example, if the measurement information 74 indicates that the current cooking temperature is at the intended temperature of 375° F., the heat source system 46 may continue to provide the same amount of energy. As a further example, if the measurement information 74 indicates that the current cooking temperature is below the intended temperature of 375° F. but rising rapidly in a such a manner that it is likely to overshoot the intended temperature, the heat source system 46 may decrease the amount of energy provided by the heat source 50. As a further example, the heat source system 46 may make any of a variety of adjustments to the amount of energy provided by the heat source based on the operation of a feedback or feed forward algorithm (for example a proportional-integral-derivative (PID) algorithm) on a series of temperature measurements or other measurement information 74.

In some examples, the user who is cooking the food item may desire to leave the kitchen while the food item is cooking. Furthermore, the user may take their wireless device 14 (such as their mobile phone) with them. This may, in some examples, cause the wireless device 14 to move out of communication range with the heat source system 46 (causing the communication link to fail). However, as a result of the second communication link between the heat source system 46 and the cooking device system 82, in some examples, the food item may still be cooked in the absence of the user and/or the wireless device 14. For example, as is discussed above, the cooking instructions 70 may include a particular duration of time (such as 10 minutes). In such an example, if the wireless device 14 moves out of communication range with the heat source system 46 before the 10 minutes has lapsed, the heat source system 46 may continue to provide the amount of energy to the cooking device 86 for the remainder of the 10 minutes. This may allow the heat source 50 to continue to cook the food item even in the absence of the user and/or the wireless device 14. As such, the wireless device 14 may not need to remain within communication range for the entire cooking process, which may free up the user and/or the wireless device 14 for extended periods of time. In such examples, the cooking system 10 may be tolerant of disconnections (or connection failures) between the wireless device 14 and the heat source system 46 and/or the cooking device system 82.

Furthermore, if the wireless device 14 returns to within communication range before the end of the duration of time, the cooking of the food item may continue on as if the user and/or wireless device 14 had never left. Alternatively, if the wireless device 14 does not return to within communication range before the end of the duration of time, the heat source system 46 may shut down or move to a hold temperature (such as a warming temperature) to prevent potential fire hazards and/or to prevent the food item from being overcooked.

As is discussed above, the cooking system 10 of FIGS. 1A-1B includes a wireless device 14. Wireless device 14 represents any suitable components that may communicate with a user so as to provide cooking information (such as cooking recipes) to the user, and that may further communicate with the heat source system 46 to assist the user in cooking. Additionally, the wireless device 14 may further communicate with the cooking device system 82 to further assist the user in cooking. Wireless device 14 may be a laptop, a mobile telephone or cellular telephone (such as a Smartphone), an electronic notebook, a tablet (such as an iPad), a personal digital assistant, a video projection device, any other device capable of receiving, processing, storing, and/or communicating information with other components of system 10, or any combination of the preceding. As is illustrated in FIGS. 1A-1B, the wireless device 14 is a tablet. Furthermore, as illustrated, wireless device 14 includes a network interface 18, a processor 22, and a memory unit 26.

Network interface 18 represents any suitable device operable to receive information from network 38 and/or network 42, transmit information through network 38 and/or network 42, perform processing of information, communicate to other devices, or any combination of the preceding. For example, network interface 18 receives measurement information 74 (such as a current temperature associated with the cooking of a food item) from the cooking device system 82. As another example, network interface 18 communicates cooking instructions 70 to the heat source system 46. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows wireless device 14 to exchange information with network 38, network 42, heat source system 46, network 78, cooking device system 82, or other components of system 10.

Processor 22 communicatively couples to network interface 18 and memory unit 26, and controls the operation and administration of wireless device 14 by processing information received from network interface 18 and memory unit 26. Processor 22 includes any hardware and/or software that operates to control and process information. For example, processor 22 executes an electronic cookbook 30 to control the operation of wireless device 14, such as to cause the wireless device 14 to communicate with a user so as to provide cooking information (such as cooking recipes) to the user, and to further communicate with the heat source system 46 to assist the user in cooking. Processor 22 may be a programmable logic device, a microcontroller, a microprocessor, any suitable processing device, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. While illustrated as including particular information modules, memory unit 26 may include any suitable information for use in the operation of wireless device 14.

As illustrated, memory unit 26 includes the electronic cookbook 30. Electronic cookbook 30 represents any suitable set of instructions, logic, or code embodied in a computer-readable storage medium and operable to facilitate the operation of wireless device 14 with regard to cooking and/or the electronic cookbook 30. Memory unit 26 may further include any other suitable set of instructions, logic, or code embodied in computer-readable storage medium and operable to facilitate other operations of wireless device 14, such as a telephone function of the wireless device 14, any other Smartphone or tablet function of the wireless device 14, any other function of the wireless device 14, or any combination of the preceding.

The electronic cookbook 30 may provide the user with instructions (and other content) associated with cooking. For example, the electronic cookbook 30 may provide the user with one or more cooking recipes and additional content that may assist the user in cooking a food item (such as a steak or chili).

Furthermore, the electronic cookbook 30 may be in communication with the heat source system 46. The electronic cookbook 30 and the heat source system 46 may be in 1:1 signal communication, e.g., via Bluetooth technology. This 1:1 signal communication may allow two-way communication, such that both the electronic cookbook 30 and the heat source system 46 (and/or the cooking device system 82) may send signals to each other, and receive signals from each other. Additionally, as described herein, the electronic cookbook 30 (and wireless device 14) and the heat source system 46 may utilize other communication schemes.

The electronic cookbook 30 may communicate with the heat source system 46 to execute one or more stages (or steps) of bringing the cooking device 86 (or a cooking environment associated with the food item) to a desired temperature as specified by the cooking recipe and for a duration of time specified by the cooking recipe. Time and/or temperature control provided by the operation of the electronic cookbook 30 may be used to eliminate mistakes that may otherwise occur when setting the amount of energy provided by the heat source 50 (e.g., heat source output). In some examples, the electronic cookbook 30 may be in signal communication with one or both of the heat source system 46 and the cooking device system 82 to cause the control of the food environment at the precise temperature set forth in the cooking recipe by measurements of temperature and modulation or adjustment of the energy provided by the heat source 50 (e.g., heating units of the heating source system 46) to maintain the food environment at precisely the desired temperature, as is discussed in further detail below.

Also, the electronic cookbook 30 may be in communication with the cooking device system 82. The electronic cookbook 30 and cooking device system 82 may be in 1:1 communication (e.g., 1:1 Bluetooth communication) for at least a portion of the cooking process. As other examples, as described herein, the electronic cookbook 30 (and wireless device 14) and the cooking device system 82 may utilize other communication schemes. The communication between the electronic cookbook 30 and the cooking device system 82 may allow the electronic cookbook 30 to check the power source level of the cooking device system 82, or check any other information associated with the cooking device system 82. Furthermore, the cooking device system 82 may advertise device or environmental information such as device ID and temperature for use by the electronic cookbook 30. Also, the cooking device system 82 may include a receiver for receiving prompts or requests from the electronic cookbook (for example) to define advertising content.

The electronic cookbook 30 may allow users, such as novice cooks, to obtain professional results because the precise control of temperature and timing afforded by the electronic control of the heat source system 46 may provide reproducible results, not requiring the use of a chefs expertise in judging food doneness from a combination of the feel, texture, and color of the food during the cooking process.

The electronic cookbook 30 may provide expert guidance in the preparation of ingredients before cooking to assist the user in achieving optimal results. For example, the electronic cookbook 30 may provide expert guidance in one or more food preparation steps required prior to cooking or one or more finishing steps after cooking to assist the user in achieving optimal results.

The electronic cookbook 30 may optionally provide additional content that may be used to increase the user's skill level and judgment of foodstuffs being at a stage (or step) to start another stage (or step) in a cooking recipe, such as from a combination of the feel, texture and color of the food during the cooking process. This guidance may be available (or optionally available) at various stages or at each stage in the cooking recipe and may include display of a picture and/or video of techniques such as cutting, dicing, filleting, mixing, or stirring techniques. A display may also include pictures and/or video of a desired appearance of food after the successful completion of a stage. As an example, after the electronic cookbook 30 provides an instruction to dice carrots to a particular size, the user may optionally view a video of a suitable dicing technique or view a video or picture of the desired prepared ingredients, e.g., how the diced carrots should look when prepared, at the end of the step.

The electronic cookbook 30 may utilize a display screen of the wireless device 14 (or any other device in communication range of the wireless device, such as a small projection display or a conveniently located display built into an appliance (e.g., a front panel display (FPD) on refrigerator)) or a virtual reality or augmented reality display device in use by a user to allow a user to easily view, receive, or play the recipe instructions. Display aspects of the electronic cookbook 30, for example, may better illustrate complicated preparation techniques compared to text. In some examples, the electronic cookbook 30 may include reminders to users of proper or safe ways to use cookware or utensils. The electronic cookbook 30 may also be configured to avoid mistakes or oversights by deploying check lists, reminders, and/or timers which may leave little room for ambiguity. Such features may be optional and selectable by the user. Display features may provide a user important information from which to decide whether to attempt a recipe. For example, a user may skip forward through the steps of a recipe to view complicated or time consuming steps before attempting them. In some examples, the electronic cookbook 30 includes a search function allowing the user to search specific foods, steps, heat source, difficulty, dietary nutrients or calories per serving, prep time, cook time, cost, or other search criteria to assist users with menu planning and special diets.

In some examples, the electronic cookbook 30 may display text of the steps of a recipe alongside a video demonstration of the step, with an audio track optionally playing either the video demonstration sound track or the text portion. For example, a traditional recipe first lists the ingredients and equipment, and at times the preparation and cooking time. The electronic cookbook 30 may be configured to present any combination of a static image and a first video segment, which could be a still shot or a pan shot showing the ingredients and/or what the finished dish looks like with nutritional information and preparation time in the text portion.

The next step in the recipe may illustrate how to prepare the ingredients, such as for example by showing how to chop, slice, dice, mix, perform any other culinary technique, or any combination of the preceding. The next steps may be presented in the order of cooking and then the final presentation.

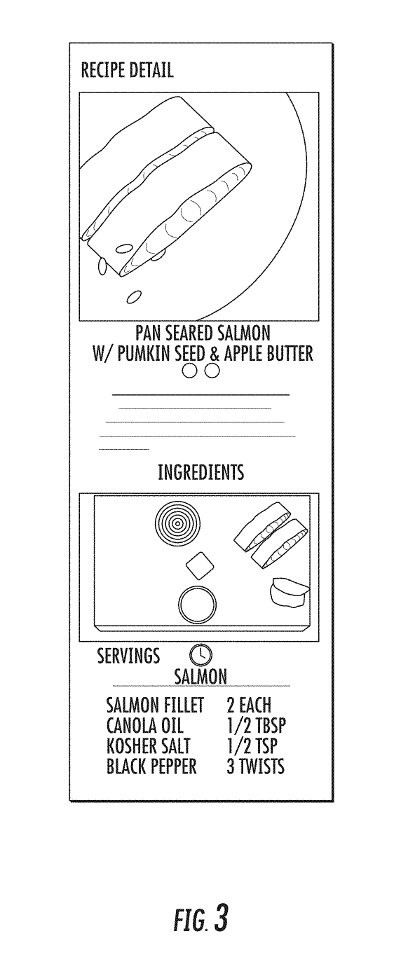

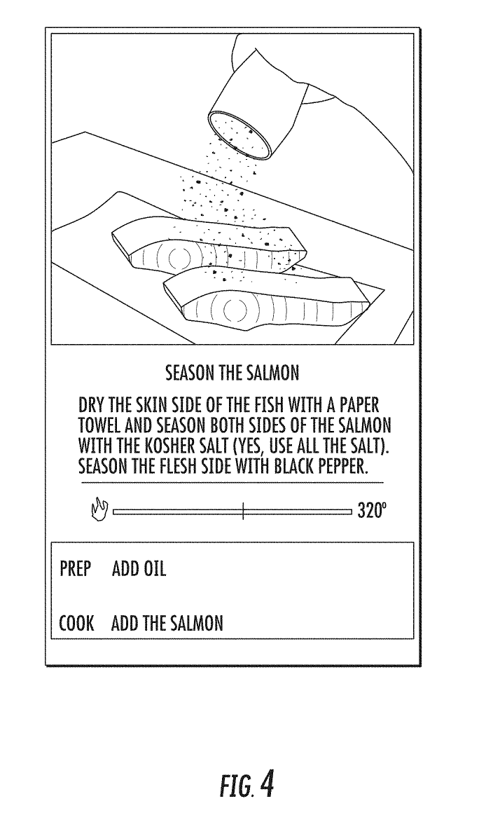

The following table outlines an example display format for a recipe displayed by the electronic cookbook 30, in which each line in the table lists the content that may be displayed, and each line may be a separate display, a portion of a scrollable display from other portions, or a highlighted portion of the entire display.

| | Optional Audio | |
|---|---|---|
| Optional Video or image content | Content | Text, UI or GUI |
| Video or still image of the finished, | The video | Title of the recipe |
| dished food item | narrative or | or food item, and |
| | reading the text | optionally |
| | | preparation time, |
| | | calories and other |
| | | nutritional |
| | | information (see |
| | | FIG. 3) |
| | | Map of the stage |
| | | (or step) in the |
| | | recipe and control |
| | | icons to skip ahead |
| | | (all steps), forward, |
| | | and backward, i.e. |
| | | one or more |
| | | navigation icons |
| | | between stages (or |
| | | steps), and content |
| | | selection (video, |
| | | picture and/or |
| | | audio), now |
| | | referred to as |
| | | Navigation icons |
| | | (see FIGS. 4-8) |
| Video pan of the ingredients, still | The video | List of ingredients |
| shots of ingredients, or videos of | narrative or | and quantities (See |
| one ingredient after another | reading the text | FIG. 3) |
| | | Navigation icons |
| Video of the preparation procedure | The video | How to prepare or |
| | narrative or | mix the |
| | reading the text | ingredients, |
| | | such as “fine dice |
| | | the celery and |
| | | onions” |
| | | (FIGS. 4-8) |
| | | Navigation icons |
| Video of the preparation step | The video | Pre-heating the |
| | narrative or | oven, cookware, |
| | reading the text | etc. |
| | | Navigation icons |
| | | Heating source |
| | | system 46 and |
| | | cooking device |
| | | system 82 |
| | | confirmation and |
| | | pairing in signal |
| | | communication |
| | | Navigation icons |
| Video of the cooking procedure, | The video | Cooking |
| showing exactly what the food | narrative, reading | procedure: |
| should look like when it is properly | the text, or alarm | Text and icons |
| cooked, optionally a running timer | when the cooking | for transmitting |
| showing how long the step should | stage should be | instruction to the |
| take at the proper temperature | finished | heat source system |
| | | 46, explaining |
| | | when to turn |
| | | or mix the food, |
| | | how to tell |
| | | when it is done, |
| | | when to put it |
| | | aside for the |
| | | next stage |
| | | (FIGS. 4-8) |
| | | icons or text |
| | | showing remaining |
| | | cooking time |
| | | navigation icons |

From the above non-limiting example of the type of information that may be displayed by the electronic cookbook 30, recipes generally involve some stage of preparation (or steps), such as gathering and measuring ingredients, and mixing and/or cooking stages. Using the above recipe display format, a user may move within a recipe between display of the stages or steps to be followed, the techniques, and the appearance of the food to obtain a full appreciation of the recipe.

For example, when a recipe includes complex steps, such as novel preparation techniques, a user may interface with the electronic cookbook 30 to visually verify that the food item the user has prepared has the proper appearance, texture, or color at one or more stages of the recipe. Therefore, before navigating to the next step in the recipe, the user may navigate through images or other content, such as text, to verify satisfactory completion of the step or stage. The electronic cookbook may also use image recognition algorithms on images of the cooking process taken by one or more cameras that are part of the wireless device 14 (or any other device in communication range of the wireless device) in order to provide feedback to the user on proper appearance, texture, color or doneness of the food.

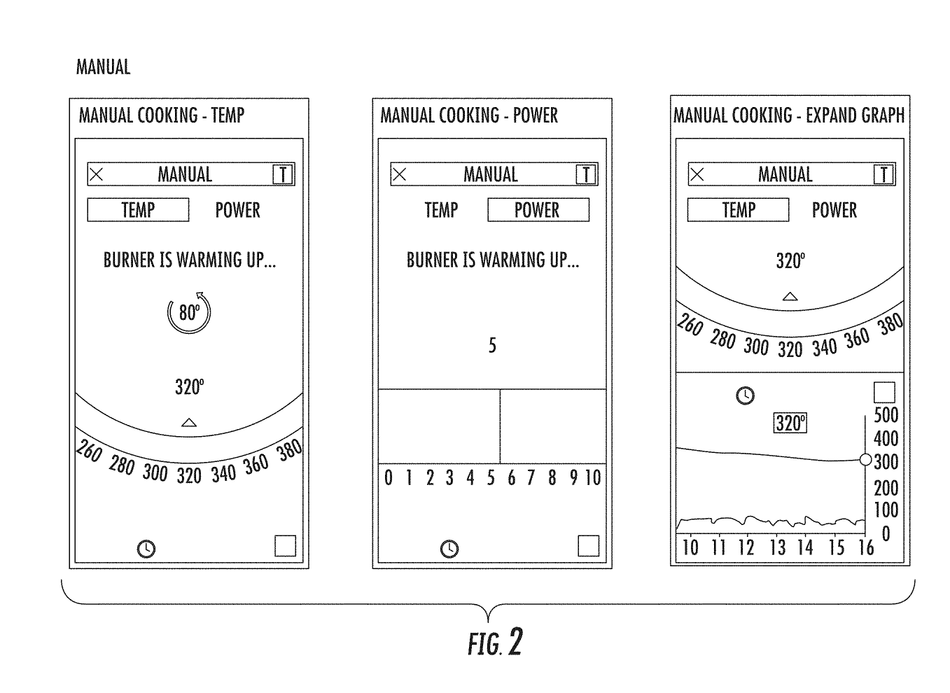

Additional information regarding the electronic cookbook 30 is discussed below. Additionally, example screenshots displayed by the electronic cookbook 30 on the wireless device 14 (or any other device) are illustrated in FIGS. 2-8.

Network 38 represents any suitable network operable to facilitate communication between the components of system 10, such as wireless device 14 and heat source system 46. Network 38 may include any interconnecting system capable of transmitting audio, video, signals, data, messages, or any combination of the preceding. Network 38 may include all or a portion of a public switched telephone network (PSTN), a public or private data network, a LAN, a MAN, a WAN, a WPAN, a local, regional, or global communication or computer network, such as the Internet, a wireline or wireless network, an enterprise intranet, or any other suitable communication link, including combinations thereof, operable to facilitate communication between the components. Preferable examples of network 38 may include a WPAN (which may include, for example, Bluetooth, Bluetooth low power, Bluetooth 5, ANT+, Zigbee (IEEE 802.15.4), other IEEE 802.15 protocols, IEEE 802.11 A, B or G without limitation, and Wi-Fi (IEEE 802.11)), a cellular communication network, an infrared communication network, any other wireless network operable to facilitate communication between the components, or any combination of the preceding.

Network 42 represents any suitable network operable to facilitate communication between the components of system 10, such as wireless device 14 and cooking device system 82. Network 42 may include any interconnecting system capable of transmitting audio, video, signals, data, messages, or any combination of the preceding. Network 42 may include all or a portion of a PSTN, a public or private data network, a LAN, a MAN, a WAN, a WPAN, a local, regional, or global communication or computer network, such as the Internet, a wireline or wireless network, an enterprise intranet, or any other suitable communication link, including combinations thereof, operable to facilitate communication between the components. Preferable examples of network 42 may include a WPAN, a cellular communication network, an infrared communication network, any other wireless network operable to facilitate communication between the components, or any combination of the preceding. Furthermore, network 42 may be the same type of network as network 38, or network 42 may be a different type of network than network 38. For example, both network 42 and network 38 may be a Bluetooth communication network. As another example, network 42 may be Wi-Fi communication network, while network 38 may be a Bluetooth communication network. Additionally, although network 42 and network 38 are illustrated as separate networks, network 42 and network 38 may be the same network.

Heat source system 46 represents any suitable components that can provide an amount of energy to cook a food item, and that can further communicate with the wireless device 14 to assist the user in cooking. Additionally, the heat source system 46 may also communicate with the cooking device system 82 to assist the user in cooking.

As is illustrated, the heat source system 46 includes a heat source 50, a network interface 54, a user interface system 56, a processor 58, and a memory unit 62. The heat source 50 may be any device that may provide an amount of energy to cook a food item. For example, the heat source 50 may be a burner (such as an induction burner, gas burner, infrared burner, and/or heating coil), a resistive heating element, a heat lamp (such as Halogen lamp), an oven, a microwave, a stove top, a range, a grill, any other device that may provide an amount of energy to cook a food item, or any combination of the preceding. As is illustrated, the heat source 50 is a gas burner that provides heat energy in the form of a gas flame. The heat source system 46 may include any number of heat sources 50.

The heat source 50 may further be connected to a power source that provide power (or energy) to the heat source 50, thereby allowing the heat source 50 to provide an amount of energy to cook a food item. The power source may be any type of power source, such as an electrical power source (e.g., a battery or a connection to an electrical outlet), a gas power source (e.g., a gas canister or a connection to a gas line), any other source of power (or energy), or any combination of the preceding.

As is discussed above, the heat source system 46 further includes network interface 54, user interface system 56, processor 58, and memory unit 62. The network interface 54, user interface system 56, processor 58, and memory unit 62 may be positioned at any location on, in, or adjacent the heat source system 46 so as to allow the interface 54 and processor 58 to communicate with the heat source(s) 50 of the heat source system 46 and/or communicate with the wireless device 14 and/or the cooking device system 82. In such an example, the processor 58 may be communicatively coupled (and potentially physically or electrically coupled) to the heat source(s) 50 and/or the wireless device 14 and/or the cooking device system 82.

Network interface 54 represents any suitable device operable to receive information from network 38 and/or network 78, transmit information through network 38 and/or network 78, receive information from heat source 50, transmit information to heat source 50, perform processing of information, communicate to other devices, or any combination of the preceding. For example, network interface 54 receives temperature information or other measurement information 74 associated with the cooking of a food item from the wireless device 14 (and the electronic cookbook 30). Network interface 54 represents any port or connection, real or virtual, (including any suitable hardware and/or software, including protocol conversion and data processing capabilities, to communicate through a LAN, MAN, WAN, or other communication system) that allows heat source system 46 to exchange information with wireless device 14, network 38, network 42, network 78, cooking device system 82, or other components of system 10.

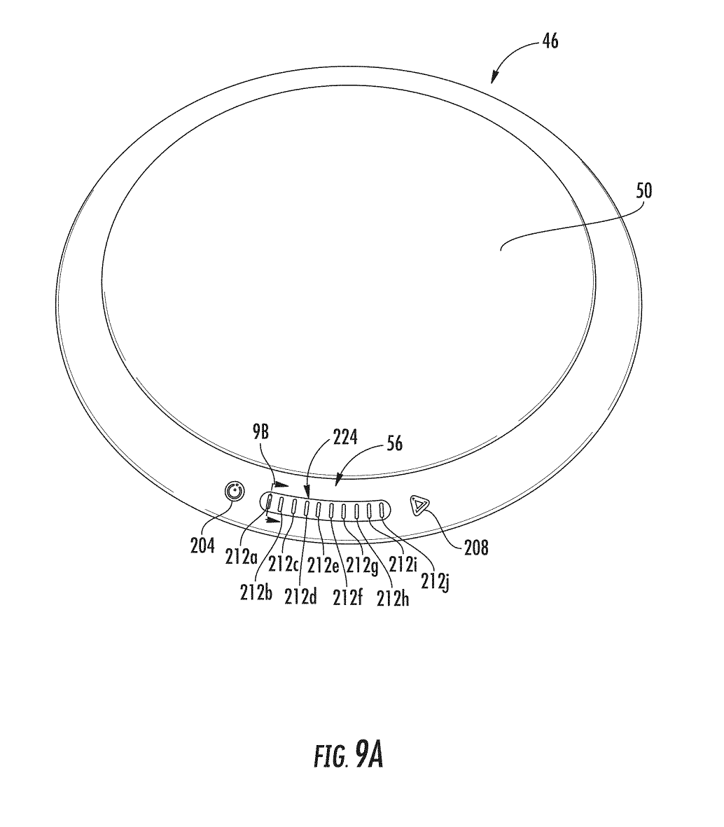

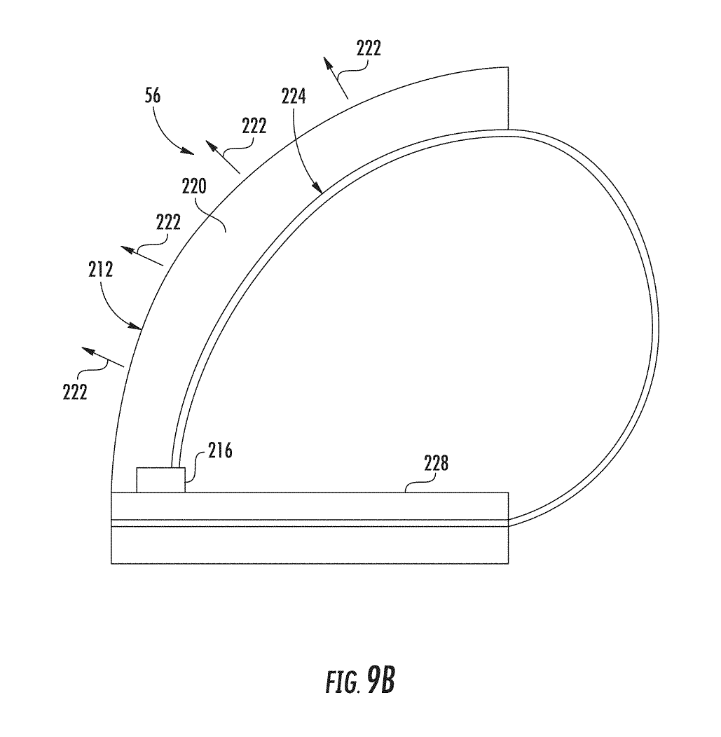

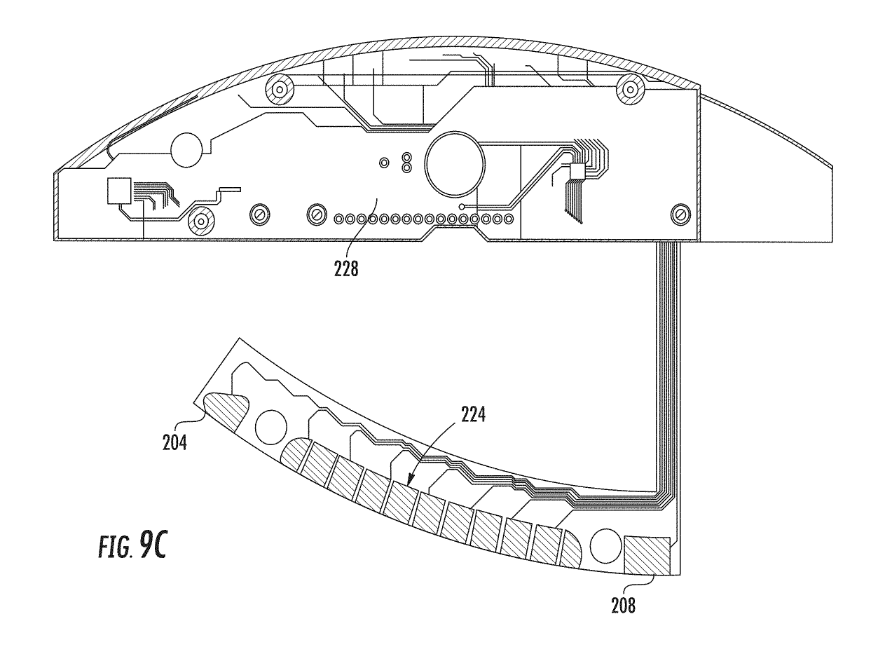

User interface system 56 represents any suitable components that allow a user to provide input to the heat source system 46 and/or that allow the heat source system 46 to provide output (such as a visual output) to the user of heat source system 46. For example, the user interface system 56 may include a touch sensor that allows the user to input a desired amount of energy that is to be used by the heat source system 46 to cook a food item. As another example, the user interface system 56 may include light sources that may provide a visual representation of the amount of energy that is currently being used by the heat source system 46 to cook a food item. Further details regarding the user interface system 56 are discussed below with regard to FIGS. 9A-9C.

Processor 58 communicatively couples to network interface 54, user interface system 56, and memory unit 62, and controls the operation and administration of heat source system 46 by processing information received from network interface 54, user interface system 56, and memory unit 62. Processor 58 includes any hardware and/or software that operates to control and process information. For example, processor 58 executes a heat source system management application 66 to control the operation of heat source system 46, such as to provide an amount of energy to cook a food item, and to communicate with the wireless device 14 to assist the user in cooking. Processor 58 may be a programmable logic device, a microcontroller, a microprocessor, any suitable processing device, or any combination of the preceding.

Memory unit 62 stores, either permanently or temporarily, data, operational software, or other information for processor 58. Memory unit 62 includes any one or a combination of volatile or non-volatile local or remote devices suitable for storing information. For example, memory unit 62 may include RAM, ROM, magnetic storage devices, optical storage devices, any other suitable information storage device, or any combination of the preceding. While illustrated as including particular information modules, memory unit 62 may include any suitable information for use in the operation of heat source system 46.

As illustrated, memory unit 62 includes heat source system management application 66, cooking instructions 70, and measurement information 74. Heat source system management application 66 represents any suitable set of instructions, logic, or code embodied in a computer-readable storage medium and operable to facilitate the operation of heat source system 46.

Cooking instructions 70 represent any set of instruction(s) that may be utilized by the heat source system 46 to assist the user in cooking. For example, the cooking instructions 70 may be a temperature that a food item is to be cooked at (such as 375° Fahrenheit), a period of time that a food item is to be cooked at a particular temperature (such as 45 minutes at 375° Fahrenheit), a food identifier that is to be added to food item (such as onions), any other information associated with cooking or a cooking recipe, or any combination of the preceding. The cooking instructions 70 may be received by the heat source system 46 from the wireless device 14.

Measurement information 74 represents any set of measurements associated with a food item in (or adjacent to) the cooking device system 82. For example, the measurement information 74 may be a current temperature associated with the food item (e.g., the current temperature the food item is being cooked at), a weight measurement associated with the food item, an acidity measurement associated with the food item, a measure of the degree to which chemical reactions associated with cooking (such as the Maillard reaction or denaturation of proteins) have occurred during cooking, any other measurement associated with the food item (or the cooking device system 82), or any combination of the preceding. The measurement information 74 may be received by the heat source system 46 from the cooking device system 82.

Network 78 represents any suitable network operable to facilitate communication between the components of system 10, such as heat source system 46 and cooking device system 82. Network 78 may include any interconnecting system capable of transmitting audio, video, signals, data, messages, or any combination of the preceding. Network 78 may include all or a portion of a PSTN, a public or private data network, a LAN, a MAN, a WAN, a WPAN, a local, regional, or global communication or computer network, such as the Internet, a wireline or wireless network, an enterprise intranet, or any other suitable communication link, including combinations thereof, operable to facilitate communication between the components. Preferable examples of network 78 may include a WPAN, a cellular communication network, an infrared communication network, any other wireless network operable to facilitate communication between the components, or any combination of the preceding. Furthermore, network 78 may be the same type of network as network 38 and/or network 42, or network 78 may be a different type of network than both network 38 and network 42. For example, each of network 38, network 42, and network 78 may be a Bluetooth communication network. As another example, network 78 may be a wired network, network 42 may be a Wi-Fi communication network, and network 38 may be a Bluetooth communication network. Additionally, although network 78, network 42, and network 38 are illustrated as separate networks, network 78 may be the same network as network 38 and/or network 42.

Cooking device system 82 represents any suitable components that may be used for cooking a food item. The cooking device system 82 may also communicate with the heat source system 46 to assist the user in cooking. Additionally, the cooking device system 82 may further communicate with the wireless device 14 to assist the user in cooking.

As is illustrated, the heat source system 46 includes a cooking device 86, measurement sensors 90 (e.g., measurement sensors 90a-90d), a network interface 94, a processor 98, and a memory unit 102. The cooking device 86 may be any device that may be used in cooking a food item. For example, the cooking device 86 may be a food support platform that may support, hold, or enclose the food item while it is being cooked, such as a pot, a pan, a vessel, a tray, a grill platen, a grate, an oven, a pressure cooker, a rice cooker, a slow cooker, a microwave oven, a toaster oven, an oven, a teapot, any other device that may support, hold, or enclose a food item while it is being cooked, or any combination of the preceding. As another example, the cooking device 86 may be a cooking utensil, such as a spoon, tongs, a spatula, a measurement probe (such as a probe that measures temperature), any other utensil that may be used while cooking a food item, or any combination of the preceding. As is illustrated, the cooking device 86 is a cooking pan.

A measurement sensor 90 (e.g., measurement sensors 90a-90d) represents any sensor that may measure or sense (or otherwise provide) a measurement associated with a food item. For example, a measurement sensor 90 may be a temperature sensor that measures a temperature of the food item, a temperature adjacent the food item (such as a temperature of a portion of the cooking device 86 or a temperature of the environment inside or adjacent the cooking device 86), a temperature that the food item is being cooked at, any other temperature associated with cooking the food item, or any combination of the preceding. As another example, the measurement sensor 90 may measure volume, weight, moisture, acidity, alkalinity, color, pressure, liquid level, the denaturing of one or more proteins, any other attributes of the food item and/or the cooking device 86, or any combination of the preceding. As a further example, the measurement sensor 90 may be a chemical sensor, an accelerometer to measure a user's physical movement of the food item and/or the cooking device 86, motion sensors or other location sensors to determine if a user and/or the food item is at a particular location, any other type of sensor, or any combination of the preceding.

All of the measurement sensors 90 may measure or sense the same type of measurement (such as temperature), or one or more of the measurement sensors 90 may measure different types of measurements than the other measurement sensors (e.g., a first set of measurement sensors 90 may measure temperature and a second set of measurement sensors 90 may measure weight and/or liquid level). As is illustrated, the measurement sensors 90 are measurement sensors 90 that measure a temperature of various portions of the cooking device 86. The measurement sensor(s) 90 may be positioned at any location in, on, or adjacent the cooking device system 82 so as to allow the measurement sensor(s) 90 to measure information associated with the food item, and to further allow the measurement sensor(s) to transmit such information to the processor 98. The measurement sensor(s) 90 may be coupled to (or otherwise positioned at) any location in, on, or adjacent the cooking device system 82, and the measurement sensor(s) 90 may be coupled to (or otherwise positioned at) such a location in any manner. As an example, the measurement sensor(s) 90 may be bonded to the location (using an adhesive, for example), connected to the location using a rivet or a clip, positioned in-between two or more materials at the location (such as two or more layers of the material of the cooking device 86), formed integral with a device at the location (such as formed integral with all or a portion of the cooking device 86), coupled to the location in any other manner, or any combination of the preceding.

As is discussed above, the cooking device system 82 further includes network interface 94, a processor 98, and a memory unit 102. The network interface 94, processor 98, and memory unit 102 may be positioned at any location on, in, or adjacent the cooking device system 82 so as to allow the interface 94 and processor 98 to communicate with the measurement sensor(s) 90, and further communicate with the wireless device 14 and/or heat source system 46.

In such an example, the processor 98 may be communicatively coupled (and potentially physically or electrically coupled) to the measurement sensor(s) 90 and/or the wireless device 14 and/or the heat source system 46. As is illustrated, the network interface 94, processor 98, and memory unit 102 are positioned in (or on) the handle of cooking device system 82. In some examples, the positioning of the network interface 94, processor 98, and memory unit 102 may protect these components from excessive heat.

Network interface 94 represents any suitable device operable to receive information from network 42 and/or network 78, transmit information through network 42 and/or network 78, receive information from measurement sensors 90, transmit information to measurement sensors 90, perform processing of information, communicate to other devices, or any combination of the preceding. For example, network interface 94 receives measurements from measurement sensors 90. As another example, network interface 94 transmits measurement information 74 to heat source system 46. Network interface 94 represents any port or connection, real or virtual, (including any suitable hardware and/or software, including protocol conversion and data processing capabilities, to communicate through a LAN, MAN, WAN, or other communication system) that allows cooking device system 82 to exchange information with wireless device 14, network 38, network 42, heat source system 46, network 78, or other components of system 10.

Processor 98 communicatively couples to network interface 94 and memory unit 102, and controls the operation and administration of cooking device system 82 by processing information received from network interface 94 and memory unit 102. Processor 98 includes any hardware and/or software that operates to control and process information. For example, processor 98 executes a cooking device system management application 106 to control the operation of cooking device system 82, such as to communicate with the heat source system 46 to assist the user in cooking, or to communicate with the wireless device 14 to assist the user in cooking. Processor 98 may be a programmable logic device, a microcontroller, a microprocessor, any suitable processing device, or any combination of the preceding.

Memory unit 102 stores, either permanently or temporarily, data, operational software, or other information for processor 98. Memory unit 102 includes any one or a combination of volatile or non-volatile local or remote devices suitable for storing information. For example, memory unit 102 may include RAM, ROM, magnetic storage devices, optical storage devices, any other suitable information storage device, or any combination of the preceding. While illustrated as including particular information modules, memory unit 102 may include any suitable information for use in the operation of cooking device system 82.

As illustrated, memory unit 102 includes cooking device system management application 106. Cooking device system management application 106 represents any suitable set of instructions, logic, or code embodied in a computer-readable storage medium and operable to facilitate the operation of cooking device system 82.

In an exemplary embodiment of operation of cooking system 10, a user may desire to cook a food item, such as steak or chili. To do so, the user may utilize their wireless device 14 (such as a mobile phone or tablet). In particular, the user may cause the wireless device 14 to execute the electronic cookbook 30. The user may cause the wireless device 14 to execute electronic cookbook 30 in any manner. For example, the electronic cookbook 30 may be an “app” installed on the wireless device 14. In such an example, the user may cause the wireless device 14 to execute the electronic cookbook 30 by selecting an icon for the electronic cookbook 30 displayed on the wireless device 14.

Once executed by the wireless device 14, the electronic cookbook 30 may display content associated with cooking. The user may navigate through the electronic cookbook 30 in order to select a particular cooking recipe to be used to cook a food item. The user may navigate through the electronic cookbook 30 in any manner. For example, the user may utilize a search function of the electronic cookbook 30 to search for a particular cooking recipe. As another example, the user may have stored favorite cooking recipes in a particular section of the electronic cookbook 30. In such an example, the user may navigate to that section (such as by clicking on the “favorites” tab in the electronic cookbook 30) in order to select a particular cooking recipe. As a further example, the electronic cookbook 30 may include suggested recipes and/or recipes that have been rated by other users or by celebrity chefs. As another example, the user may scroll through all (or a portion) of the cooking recipes to select a particular recipe.

Once a particular recipe (such as a recipe for chili, for example) has been selected, the electronic cookbook 30 may display on the wireless device 14 the cooking recipe associated with the selected food item. The electronic cookbook 30 may display the entire cooking recipe on the wireless device 14, or only a portion of the cooking recipe on the wireless device 14. The cooking recipe may include any information that may be utilized in cooking the food item, such as steps (or stages) for preparing the food item, a list of ingredients for the food item, a list of quantities of ingredients for the food item, a list of substitute ingredients for the food item, a list of devices or appliances that may be used to cook the food item (such as a description and/or picture of a particular pot/pan, a description and/or picture of a particular type of appliance (such as an oven or grill) that should be used to cook the food item, etc.), any other information associated with the food item, or any combination of the preceding. The cooking recipe may also include instructional videos associated with cooking the food item and/or pictures associated with ingredients of the food item (such as a picture of an onion, a picture of a diced onion, a picture of what an onion looks like after being caramelized, etc.).

The electronic cookbook 30 may further include a step-by-step guide for cooking the food item in accordance with the cooking recipe. This step-by-step guide may navigate the user through each step in the cooking process. For example, the cooking recipe for chili may include the following steps: (1) meat is added to the pot and browned at a particular temperature (such as 375° F.) for a particular duration of time (such as 10 minutes); (2) onions and or other ingredients are added to the browned meat; (3) this combination of ingredients is cooked at a second particular temperature (such as 300° F.) for a second particular duration of time (such as 5 minutes); (4) tomatoes, tomato sauce, and spices are added; (5) this combination of ingredients is cooked at a third particular temperature (such as 212° F.) for a third particular duration (till the tomato sauce combination is reduced by ½); and (6) the entire food item is cooked at a fourth temperature (such as 180° F.) for a fourth particular duration of time (such as 4 hours).

In the step-by-step guide, each of the above example steps for chili may be displayed individually (or individually highlighted in the cooking recipe to identify the current step). For a current step, the wireless device 14 may display information that explains the current step in the cooking recipe, and further explains what the user is supposed to do during that step. Once the step has been completed, the user may be prompted to indicate that the step has been completed, such as by clicking on a “next” button displayed on the wireless device 14. This may allow the user to navigate to the next step. The user may click on a button of the wireless device 14 or the screen of the wireless device 14 to activate such a “next” button. Additionally (or alternatively), the user may click on any other button (or control device) to navigate through the steps (or stages).

The step-by-step guide may further include additional information associated with cooking the food item. For example, if the first step for cooking chili is to add meat to a cooking device 86 (such as a 5 quart pot), the first step in the step-by-step guide may include pictures of the recommended cooking device 86, pictures of the recommended heat source 50 (such as a burner) that should be used to cook the meat, nutritional information associated with the meat, information about the type of animal that the meat comes from, instructional videos on how to handle the meat, instructional videos and/or other information associated with sanitizing your hands after touching the meat, other information associated with the particular step, or any combination of the preceding.

Following the selection of a particular cooking recipe (such as chili), the wireless device 14 may prompt the user to select which heat source system 46 and which cooking device system 82 the user will use to cook the food item. The wireless device 14 may prompt the user to select the heat source system 46 and cooking device system 82 by displaying descriptions and/or pictures of various heat source systems 46 and cooking device systems 82 that may be proper for a particular recipe. For example, if the recipe recommends that the user use a burner to cook the chili, the wireless device 14 may prompt the user to select which burner on a grill or stovetop (such as the front left burner of the stovetop) they intend to use to cook the chili. As another example, if the recipe recommends that the user use either a 5 quart pot or a 10 quart pot to cook the chili, the wireless device 14 may prompt the user to select which of the 5 quart pot or a 10 quart pot they intend to use to cook the chili.

In order to display descriptions and/or pictures of heat source systems 46 and/or cooking device systems 82, the wireless device 14 (and electronic cookbook 30) may receive information about each heat source system 46 and/or cooking device system 82 that is available for use in a particular kitchen. The information may be received in any manner. For example, the heat source systems 46 and cooking device systems 82 may have been pre-registered with the wireless device 14 and the electronic cookbook 30 when the heat source systems 46 and/or cooking device systems 82 are purchased. Such pre-registration may allow the wireless device 14 to know that they are available (e.g., to know that they are available in that particular kitchen). As another example, the wireless device 14 may communicate with the heat source systems 46 and cooking device systems 82 to know that they are available. In such an example, the heat source systems 46 and cooking device systems 82 may broadcast advertisement packets (such as Bluetooth advertisement packets) that advertise the heat source systems 46 and cooking device systems 82. This may allow the wireless device 14 to know which heat source systems 46 and cooking device systems 82 are available in the kitchen. The wireless device 14 may also use the strength of broadcast signals from heat source systems 46 and cooking device systems 82 to determine which are nearby. Wireless device 14 may also use technology such as Near Field Communication (NFC) to determine which heat source systems 46 and cooking device systems 82 are nearby. In some examples, heat source system 46 may use any of the above techniques to discover which cooking device systems 82 are in its vicinity, and may further communicate that information to wireless device 14. In other examples, cooking device system 82 may use any of the above techniques to discover which heat source systems 46 are in its vicinity, and may further communicate that information to wireless device 14.

Instead of (or in addition to) prompting a user to select which heat source system 46 and cooking device system 82 that will be used to cook the food item, the wireless device 14 may instruct the user to use a particular heat source system 46 and/or cooking device system 82. For example, the wireless device 14 may analyze the cooking recipe to determine what heat source system 46 and cooking device system 82 are acceptable for the recipe. Furthermore, the wireless device 14 may further determine what heat source systems 46 and cooking device systems 82 are available in a kitchen. Based on these determinations, the wireless device 14 may compare the results to determine the best fit for the particular recipe. Additionally, the wireless device 14 may show the user a description and/or picture of which heat source system 46 and/or cooking device system 82 to use.

The wireless device 14 may also send a signal to the heat source system 46 and/or cooking device system 82 to help the user locate the recommended heat source system 46 and/or cooking device system 82. This signal may cause the recommended heat source system 46 and/or cooking device system 82 to provide an indication (such as a visual indication and/or an audible indication) to the user. To provide the indication, the heat source system 46 and/or cooking device system 82 may include a lighting system that may light up (or blink), a speaker system that may emit the audible sound, any other indication system, or any combination of the preceding. The indication(s) may assist the user in determining which heat source system 46 and/or cooking device system 82 to use.

Following the selection of a particular heat source system 46, the wireless device 14 may establish a first communication link with the selected heat source system 46. The first communication link, for example, may be with the front left gas burner of a stovetop or may be a common or single communication link through which the communication link is shared among the various burners of a multi-burner stovetop. This communication link may be established over network 38, as is illustrated in FIG. 1B. The wireless device 14 may establish any type of communication link with the heat source system 46, and may establish the communication link in any manner. As an example, the wireless device 14 may establish a WPAN communication link (e.g., a Bluetooth communication link, a Wi-Fi communication link), an infrared communication link, a cellular communication link, any other wireless communication link, or any combination of the preceding. Additionally, the wireless device 14 may establish the communication link in any manner. For example, the wireless device 14 may establish the communication link by sending a request for a communication link to another device, accepting another device's request for a communication link, responding to an advertisement or any other transmittal, sending an advertisement or any other transmittal, any other manner of establishing a communication link, or any combination of the preceding.

As is illustrated in FIG. 1B, the wireless device 14 establishes a Bluetooth communication link with the heat source system 46. The communication link may be any type of Bluetooth communication link. For example, the communication link may be a 1:1 Bluetooth link, where the wireless device 14 operates as the central device, and the heat source system 46 operates as the peripheral device.

Following the selection of a particular cooking device system 82, the heat source system 46 may establish a second communication link with the selected cooking device system 82. This second communication link may be established over network 78, as is illustrated in FIG. 1B. The heat source system 46 may establish any type of communication link with the cooking device system 82. As an example, the heat source system 46 may establish a WPAN communication link (e.g., a Bluetooth communication link, a Wi-Fi communication link), an infrared communication link, a cellular communication link, any other wireless communication link, a wired communication link (such as when the cooking device system 82 is a cooking pan that is in a physical connection with a heat source system 46 that is a rice cooker or a slow cooker), or any combination of the preceding. Additionally, the heat source system 46 may establish the communication link in any manner. For example, the heat source system 46 may establish the communication link by sending a request for a communication link to another device, accepting another device's request for a communication link, responding to an advertisement or any other transmittal, sending an advertisement or any other transmittal, any other manner of establishing a communication link, or any combination of the preceding.

The second communication link (in-between the heat source system 46 and the cooking device system 82) may be the same type of communication link as the first communication link (in-between the wireless device 14 and the heat source system 46). For example, both the second communication link and the first communication may be Bluetooth communication links. As another example, the second communication link and the first communication link may be different types of communication links. For example, the second communication link may be a wired communication link and the first communication link may be a Bluetooth communication link or a Wi-Fi communication link.

As illustrated in FIG. 1B, the second communication link between the heat source system 46 and the cooking device system 82 is a Bluetooth communication link. The second communication link may be any type of Bluetooth communication link, and the second communication link may be established in any way.

For example, the second communication link may be a communication link where the heat source system 46 receives Bluetooth advertisement packets from the cooking device system 82, and the heat source system 46 then uses the Bluetooth advertisement packets to request Bluetooth scan response packets (or other types of packets) from the cooking device system 82. The heat source system 46 may establish such a second communication link in any manner. For example, the heat source system 46 may establish this communication link based on information received from the wireless device 14. In such an example, the wireless device 14 may obtain the Bluetooth unique identifier for the cooking device system 82 from the Bluetooth advertisement packets broadcasted by the cooking device system 82. The wireless device 14 may then transmit this Bluetooth unique identifier for the cooking device system 82 to the heat source system 46. The heat source system 46 may use this Bluetooth unique identifier to filter out or ignore any other Bluetooth advertisement packets (or other advertisement packets), other than those broadcasted by the cooking device system 82. Additionally, when the heat source system 46 receives a Bluetooth advertisement packet from the cooking device system 82, the heat source system 46 may use an identifier in the Bluetooth advertisement packet to request Bluetooth scan response packets (or other types of packets) from the cooking device system 82.

In another example, the second communication link may be a communication link where the cooking device system 82 obtains the Bluetooth unique identifier of the heat source system 46, and then the cooking device system 82 may use this Bluetooth unique identifier to send packets (such as scan response packets) directly to the heat source system 46. In such an example, cooking device system 82 may obtain the Bluetooth unique identifier of the heat source system 46 from the wireless device 14. For example, the wireless device 14 may obtain the Bluetooth unique identifier for the heat source system 46 from the Bluetooth advertisement packets broadcasted by the heat source system 46 (or from the 1:1 Bluetooth connection with the heat source system 46), and then the wireless device 14 may transmit this Bluetooth unique identifier for the heat source system 46 to the cooking device system 82. The cooking device system 82 may then use this Bluetooth unique identifier to send packets (such as scan response packets) directly to the heat source system 46, for example.

Following the selection of a particular cooking device system 82, the wireless device 14 may also establish a third communication link with the selected cooking device system 82. This third communication link may be established over network 42, as is illustrated in FIG. 1B. The wireless device 14 may establish any type of communication link with the cooking device system 82. As an example, the wireless device 14 may establish a WPAN communication link (e.g., a Bluetooth communication link, a Wi-Fi communication link), an infrared communication link, a cellular communication link, any other wireless communication link, or any combination of the preceding. Additionally, the wireless device 14 may establish the communication link in any manner. For example, the wireless device 14 may establish the communication link by sending a request for a communication link to another device, accepting another device's request for a communication link, responding to an advertisement or any other transmittal, sending an advertisement or any other transmittal, any other manner of establishing a communication link, or any combination of the preceding.

The third communication link (in-between the wireless device 14 and the cooking device system 82) may be the same type of communication link as the second communication link (in-between the heat source system 46 and the cooking device system 82) and the first communication link (in-between the wireless device 14 and the heat source system 46). For example, each of the third communication link, the second communication link, and the first communication link may be a Bluetooth communication link. As another example, the third communication link may be a different type of communication link than the second communication link and/or the first communication link. For example, the third communication link may be a Wi-Fi communication link, the second communication link may be a wired communication link, and the first communication link may be a Bluetooth communication link.

As is illustrated in FIG. 1B, the third communication link between the wireless device 14 and the cooking device system 82 is a Bluetooth communication link. The third communication link may be any type of Bluetooth communication link. For example, the third communication link may be a communication link where the wireless device 14 receives Bluetooth advertisement packets from the cooking device system 82, and the wireless device 14 uses the Bluetooth advertisement packets to request Bluetooth scan response packets (or other types of packets) from the cooking device system 82. This may allow the wireless device 14 to receive measurement information 74, and display such measurement information 74 to the user on the display of the wireless device 14. For example, the wireless device 14 may receive an indication of the current temperature associated with the food item, and may display a graphical representation of this current temperature associated with the food item (e.g., a graphical representation of 375° F.). Examples of the graphical representations that may be displayed by the wireless device 14 are seen in FIG. 2, and include the current temperature associated with the food item, the amount of energy being provided by the heat source 50, and/or any other information associated with the cooking of the food item. In some examples, the use of Bluetooth scan request and scan response packets, or similar broadcast packets may obviate the need for the cooking device system 82 and the wireless device 14 to have a 1:1 communication link.

Following the establishment of the first communication link between the wireless device 14 and the heat source system 46, the wireless device 14 may transmit cooking instructions 70 to the heat source system 46. The cooking instructions 70 may include any information associated with cooking the food item. For example, the cooking instructions 70 may include temperatures that a food item is to be cooked at and/or durations of time that the food item is to be cooked at the particular temperatures. Additionally, the cooking instructions 70 may include ingredients that are to be added to food item, steps that are to be performed by a user to cook the food item, any other information associated with cooking the food item, or any combination of the preceding.

The cooking instructions 70 may include information for an entire recipe, or may include information for only a portion of the recipe. For example, the cooking instructions 70 may only include information for a particular step in a step-by-step guide for cooking a food item. In such an example, when a particular step is finished, additional cooking instructions 70 may be sent to the heat source system 46. These additional cooking instructions 70 may include information for the next step. As another example, the cooking instructions 70 may include information for two or more particular steps in a step-by-step guide for cooking a food. These cooking instructions 70 may also be supplemented with additional cooking instructions 70 (if needed) as the user progresses through the cooking recipe.

As is illustrated, the cooking instructions 70 include at least an indication of a temperature, and an indication of a duration of time, for at least one of the steps of the cooking recipe. The indication may be data (or other information) that may allow the heat source system 46 to determine the temperature and/or the duration of time. For example, the indication may be the temperature itself (e.g., 375° F.) and/or the duration of time itself (e.g., 10 minutes), or it may be a signal or pointer (or any other type of data) that may be used by the heat source system 46 to determine the temperature and/or the duration of time. In the example discussed above with regard to a cooking recipe for chili, the cooking instructions 70 may include information associated with the first step of the cooking recipe (which provides for browning the meat at 375° F. for a duration of 10 minutes). As such, the cooking instructions 70 may include an indication of a temperature (e.g., 375° F.) and an indication of a duration of time (e.g., 10 minutes) for the first step.

Although the cooking instructions 70 have been described above as being received from the wireless device 14 through the first communication link, in some examples, the wireless device 14 may utilize an intermediary device to provide the cooking instructions 70. For example, if the first communication link (in-between the wireless device 14 and the heat source system 46) fails (or if a back-up set of the information is desired), the wireless device 14 may send the cooking instructions 70 to the heat source system 46 through the intermediary device (such as another wireless device 14, or the cooking device system 82).

Based on receiving the cooking instructions 70 (which may include an indication of a 375° F. temperature and an indication of a 10 minute duration of time), the heat source system 46 (via the processor 58, for example) may activate the heat source 50, so as to begin providing energy to the cooking device 86 of the cooking device system 82. Alternatively, if the heat source 50 is already activated, the heat source system 46 (via the processor 58, for example) may adjust the amount of energy being provided by the heat source 50 to the cooking device 86.

The amount of energy provided by the heat source 50 may also be based on the type of cooking device system 82 that is being used to cook the food item. For example, the heat source system 46 may store (or access) a profile associated with the particular cooking device system 82. Such a profile may include a type of cooking device 86 (e.g., a pot), of volume of the cooking device 86 (e.g., 5 quarts), a material type of the cooking device 86 (e.g., copper bottom), any other information associated with the cooking device 86 of the cooking device system 82, or any combination of the preceding. Using this profile, the heat source system 46 may adjust the amount of energy provided to the cooking device 86 by the heat source 50. For example, if the cooking device 86 is made of a material that heats to a higher temperature with a lower amount of energy, the heat source system 46 (via the processor 58, for example) may adjust the amount of energy provided to the cooking device 86 in accordance with such a profile.

While the heat source 50 is providing energy to the cooking device 86 in accordance with the cooking instructions 70, the heat source system 46 may receive information from the cooking device system 82 that may assist the heat source system 46 in cooking the food item. As is discussed above, the cooking device system 82 may include measurement sensors 90 that may measure or sense (or otherwise provide) a measurement associated with the food item. For example, the measurement sensors 90 may measure a current temperature associated with the food item (such as a current temperature of a food item, a current temperature of a portion of the cooking device 86 adjacent the food item, or a current temperature that the food item is being cooked at). Based on the measurements from the measurement sensors 90, the cooking device system 82 may transmit measurement information 74 to the heat source system 46 using the second communication link.

The measurement information 74 may include any information that may be measured using the measurement sensors 90. For example the measurement information 74 may include an indication of the current temperature that the food item is being cooked at. This indication may be data (or other information) that may allow the heat source system 46 to determine the current temperature that the food item is being cooked at. For example, the indication may be the current temperature itself (e.g., 375° F.) or may be a signal or pointer (or any other type of data) that may be used by the heat source system 46 to determine that the current temperature is 375° F. Additionally (or alternatively), the measurement information may include an indication of the current liquid level of the food item, or an indication of any other measurable information associated with cooking the food item.

The heat source system 46 may use the measurement information 74 to check (continuously or periodically) the amount of energy being applied to the cooking device 86. For example, if the heat source 50 is providing an amount of energy that is intended to cook the food item at 375° F., but the measurement information 74 indicates that the food is being cooked at a temperature of 350° F., the heat source system 46 may increase the amount of energy being applied to the cooking device 86. As another example, if the heat source 50 is providing an amount of energy that is intended to cook the food item at 375° F., but the measurement information 74 indicates that the food is being cooked at a temperature of 400° F., the heat source system 46 may decrease the amount of energy being applied to the cooking device 86. As a further example, if the heat source system 46 is providing an amount of energy that is intended to cook the food item at 375° F., and the measurement information indicates that the food is being cooked at a temperature of 375° F., the heat source system 46 may allow the heat source 50 to continue to provide the same amount of energy to the cooking device 86. As a further example, if the measurement information 74 indicates that the current cooking temperature is below the intended temperature of 375° F. but rising rapidly in a such a manner that it is likely to overshoot the intended temperature, the heat source system 46 may decrease the amount of energy provided by the heat source 50. As a further example, the heat source system 46 may make any of a variety of adjustments to the amount of energy provided by the heat source 50 based on the operation of a feedback or feedforward algorithm (for example a PID algorithm) on a series of temperature measurements 74. Example PID algorithms for use in cooking are described in U.S. Pat. No. 8,692,162 entitled “Oven control utilizing data-driven logic”, and U.S. Pat. No. 8,800,542 entitled “Automatic temperature control device for solid fuel fired food cooker,” both of which are incorporated herein by reference.

The heat source system 46 may further use the measurement information 74 to check (continuously or periodically) for potential errors in the cooking process. For example, a user may have positioned the wrong cooking device system 82 on the heat source 50. In such an example, the heat source system 46 may utilize the measurement information 74 and a profile of the correct cooking device system 82 to determine that the wrong cooking device system 82 is currently positioned on the heat source 50. In particular, the profile for the correct cooking device system 82 may indicate that a particular amount of energy (such as a medium-high level) applied to the correct cooking device 86 should cause the food item to be cooked at a particular temperature (such as 375° F.). However, if the wrong cooking device system 82 is positioned on the heat source 50, the measurement information 74 received from the correct cooking device system 82 may indicate that the current temperature is too low for the amount of energy being provided by the heat source 50. Based on this, the heat source system 46 may determine that the wrong cooking device system 82 is positioned on the heat source 50. The heat source system 46 may then send an error signal to the wireless device 14, which may alert the user to the error. Such an error correction system may be particularly advantageous when multiple heat sources 50 are being used to apply energy to multiple cooking devices 86 so as to cook multiple different types of food items at similar (or identical) time periods. A heat source 50 could also determine which cooking device system 82 is positioned on top of or in it for cooking purposes by analyzing the strength of any wireless signals coming from the various cooking device systems 82 in vicinity of the heat source 50.

As further examples, the heat source system 46 may be able to use the measurement information 74 to determine that the wrong ingredients have been added to the cooking device system 82 (such as if the acidity of the food item is incorrect), that too much (or too little) of a particular ingredient has been added to the cooking device system 82 (such as if the amount of weight in the cooking device 86 is too high (or too low)), that the cooking device 86 is too full (or too empty), that the food item is boiling (or any other phase change is occurring), that the food item is about to boil over, that the food item has completely boiled away, that the acidity of the food item is incorrect, that the food item is heating improperly, that the food item has reached the desired texture (such as crispy) or doneness, that the lid of the cooking device 86 has been left off of the cooking device 86 (or left on the cooking device 86), any other information associated with an error in the cooking process, or any combination of the preceding.

As is discussed above, the cooking device system 82 may provide measurement information 74 to the heat source system 46. The cooking device system 82 may provide the measurement information 74 in any manner. For example, the cooking device system 82 may transmit the measurement information 74 using a Bluetooth communication link. To do so, the cooking device system 82 may periodically transmit Bluetooth advertisement packets that may identify the cooking device system 82. When the heat source system 46 receives such a Bluetooth advertisement packet, the heat source system 46 may request additional information from the cooking device system 82. In response to this request, the cooking device system 82 may activate one or more of the measurement sensors 90 so as to begin receiving measurements from the measurement sensors 90. Based on these measurements, the cooking device system 82 may create measurement information 74, and insert this measurement information 74 into a Bluetooth scan response packet (or any other type of Bluetooth packet). The measurement information 74 may be added into any suitable field in the Bluetooth scan response packet, such as a special field reserved for manufacturer-specific advertising data. The Bluetooth scan response packet may then be broadcast (or otherwise sent) to the heat source system 46 that requested the additional information. In some examples, each time a Bluetooth scan response packet is constructed, the most current measurement information 74 may be embedded in the Bluetooth scan response packet.

Typically, a Bluetooth scan response packet is a packet used by a peripheral device to provide more information than fits in a Bluetooth advertisement packet. This additional information may tell a device examining the advertisement and scan response packets about the services the peripheral provides, the name of the peripheral, and related information the receiver of the advertisement packet might want to know to determine whether it wants to connect with the peripheral. Unlike traditional Bluetooth scan response packets (whose content is always the same), the Bluetooth scan response packets created by the cooking device system 82 may have content that changes in-between successive Bluetooth scan response packets, as each Bluetooth scan response packet may include the most current measurement information 74 (which can change over time). Additional information regarding advertisement packets and/or scan response packets (or scanning packets) is discussed in the following documents, all of which are incorporated herein by reference: U.S. Patent Application Publication No. 2013/0003630 entitled “Connection Setup for Low Energy Wireless Networks Based on Scan Window and Scan Interval Estimation”; U.S. Patent Application Publication No. 2014/0321321 entitled “Method and Technical Equipment for Short Range Data Transmission”; U.S. Patent Application Publication No. 2015/0172391 entitled “Method, Apparatus, and Computer Program Product for Network Discovery”; U.S. Patent Application Publication No. 2015/0172902 entitled “Method, Apparatus, and Computer Program Product for Service Discovery in Wireless Short-Range Communication”; U.S. Patent Application Publication No. 2016/0029149 entitled “Low Power Consumption Short Range Wireless Communication System”; U.S. Pat. No. 6,795,421 entitled “Short-Range RF Access Point Design Enabling Services to Master and Slave Mobile Devices”; U.S. Pat. No. 7,602,754 entitled “Short-Range RF Access Point Design Enabling Services to Master and Slave Mobile Devices”; U.S. Pat. No. 8,588,688 entitled “Non-Networked Messaging”; U.S. Pat. No. 8,737,917 entitled “Method and System for a Dual-Mode Bluetooth Low Energy Device”; U.S. Pat. No. 8,817,717 entitled “Concurrent Background Spectral Scanning for Bluetooth Packets While Receiving WLAN Packets”; U.S. Pat. No. 9,185,652 entitled “Bluetooth Low Energy Module Systems and Methods”; U.S. Pat. No. 9,258,695 entitled “Method, Apparatus, and Computer Program Product for Service Discovery in Short-Range Communication Environment”; U.S. Pat. No. 9,357,342 entitled “Short-Range Wireless Controller Filtering and Reporting”; U.S. Pat. No. 9,414,217 entitled “Method and Technical Equipment for Short Range Data Transmission”; U.S. Pat. No. 9,456,295 entitled “Method and Apparatus for Receiving Content Based on Status of Terminal”; U.S. Pat. No. 9,538,356 entitled “Method and Apparatus for Bluetooth-Based General Service Discovery”; and U.S. Pat. No. 9,544,755 entitled “Method, Apparatus, and Computer Program Product for Non-Scannable Device Discovery”.

In some examples, these steps may allow the cooking device system 82 to conserve its power source (such as a battery), allowing the power source to last longer. For example, by utilizing Bluetooth scan response packets to transmit information, in some examples, the cooking device system 82 may be able to transmit current measurement information 74 (e.g., current temperature data) without the computational and battery-life-limiting overhead associated with establishing and maintaining a formal Bluetooth connection. As another example, the cooking device system 82 may only utilize its measurement sensors 90 when additional information is requested. This may allow the measurement sensors 90 to remain dormant for long periods of time (such as when the cooking device system 82 is not being used at all), and reduce the amount of energy being used by the cooking device system 82. In other examples, the cooking device system 82 may constantly be using its measurement sensors 90 or using its measurement sensors 90 during a period when the user turns on the cooking device system 82 (such as by pressing a power button). In such examples, the cooking device system 82 may transmit measurement information 74 any time the measurement sensors 90 are activated, or only when the measurement information 74 is requested.

Although the steps discussed above have been described in relation to a Bluetooth communication link, such steps (or similar steps) may be performed for any other communication link, such as any other WPAN communication link (e.g., Bluetooth low power, Bluetooth 5, ANT+, Zigbee (IEEE 802.15.4), other IEEE 802.15 protocols, IEEE 802.11 A, B or G without limitation, or Wi-Fi (IEEE 802.11)), a cellular communication link, an infrared communication link, any other wireless communication link, any other communication link, or any combination of the preceding. Additionally, although the measurement information 74 has been described above as being sent to the heat source system 46 (using the second communication link), the measurement information 74 may also be sent to the wireless device 14 (using the third communication link). In such examples, the wireless device 14 may request the additional information after also receiving an advertisement packet (as is discussed above). By receiving the measurement information 74, the wireless device 14 may be able to display the information included in the measurement information 74 (such as the current temperature associated with the food item) to the user. The wireless device 14 may also be able to provide this information to the heat source system 46 if the second communication link (in-between the heat source system 46 and the cooking device system 82) fails (or if a back-up set of the information is desired), and/or the heat source system 46 may be able to provide this information to the wireless device 14 if the third communication link (in-between the wireless device 14 and the cooking device system 82) fails (or if a back-up set of the information is desired).

While the heat source 50 is providing energy to the cooking device 86 in accordance with the cooking instructions 70, the heat source system 46 may further keep track of the amount of time that the energy has been provided to the cooking device 86. This may allow the heat source system 46 to cook the food item at a particular temperature for a particular amount of time. For example, as is discussed above, the cooking instructions 70 may indicate that the food item is to be cooked at 375° for 10 minutes. In such an example, the heat source system 46 may keep track of the amount of time that it has been providing energy to the cooking device 86 for that particular step. When the duration of time has elapsed (or when the duration of time is close to lapsing, such as five minutes before lapsing, two minutes before lapsing, and/or one minute before lapsing), the heat source system 46 may send a signal to the wireless device 14 indicating that the duration of time has lapsed (or that the duration of time is close to lapsing). This may cause the wireless device 14 to alert the user, such as by making an audible sound, vibrating, texting the user, calling the user, or any other manner of alerting the user. The alert may inform the user that it is time to move to the next step (or that it is almost time to move to the next step).

Additionally (or alternatively), the wireless device 14 may also keep track of the time that has elapsed for that particular step. As such, the wireless device 14 may be able to alert the user of the time even without receiving a signal from the heat source system 46. Furthermore, the wireless device 14 may also provide a continuous countdown (or periodic updates) of the time left in the duration of time (such as 2 minutes and 30 seconds left till the next step).

When a step of the cooking recipe has been completed (such as when the first step of browning meat at 375° F. for 10 minutes, has been completed), the wireless device 14 may move to the next step. This movement to the next step (such as step two of the cooking recipe) may cause the wireless device 14 to display the next step to the user. Alternatively, if more than one step is already being displayed by the wireless device, such movement to the next step may cause the next step to be highlighted in some manner on the display to indicate that the next step is now the current step. The movement to the next step may also cause the wireless device 14 to transmit new cooking instructions 70 to the heat source system 46. The new cooking instructions 70 may include information associated with the new step. Alternatively, if the heat source system 46 already has access to all (or more than one set) of the cooking instructions 70 for the cooking recipe, the wireless device 14 may send an instruction to the heat source system 46 to move to the next step in the cooking instructions 70.

As is discussed above with regard to the chili example, the next step (e.g., step 2) may include the user adding onions and other ingredients. In such an example, the new cooking instructions 70 may include information that indicates that the heat source system 46 should continue to provide the same cooking temperature (e.g., 375° F.) for a duration of time (e.g., 5 minutes) to allow the user time to add the onions and other ingredients.

When this next step has been completed by the user, the user may indicate to the wireless device 14 that the step has been completed, such as by clicking the “next” button in the electronic cookbook 30. Additionally (or alternatively), the heat source system 46 may attempt to determine when the step has been completed. For example, the heat source system 46 may have stored information that indicates that the addition of ingredients to the food item should cause a sudden change in the current temperature associated with the food item. In such an example, after the ingredients have been added, the heat source system 46 may receive measurement information 74 that indicates that the current temperature associated with the food item has suddenly changed in a manner that is consistent with the addition of the ingredients. Based on this, the heat source system 46 may transmit a signal to the wireless device 14, indicating that the step has been completed. This may prevent the user from having to manually indicate that the step has been completed.

Alternatively, if the user has incorrectly indicated that the step has been completed, the heat source system 46 may be able to determine that this indication is incorrect. For example, if the heat source system 46 does not receive measurement information 74 that indicates, for example, a sudden change in the current temperature that the food item is being cooked at consistent with the addition of ingredients, the heat source system 46 may be able to determine that the ingredients have not been added. As such, the heat source system 46 may transmit an error message to the wireless device 14, which may cause the wireless device 14 to alert the user to the error.

Following the completion of the step (such as the completion of step 2, where onions and other ingredients were added to the food item), the wireless device 14 may move to the next step. Similar to the previous steps, such movement may cause the next step to be displayed to the user, and may further cause new cooking instructions 70 to be transmitted to the heat source system 46. As is discussed above with regard to the chili example, the next step (e.g., step 3) may include cooking the combination of ingredients at 300° F. for a duration of 5 minutes. In such an example, the new cooking instructions 70 may include the particular temperature (e.g., 300° F.) and the particular duration of time (e.g., 5 minutes).

In such an example, the heat source system 46 may reduce the amount of energy provided to the cooking device 86 in accordance with the cooking instructions 70, thereby causing the food item to be cooked at the lower temperature of 300° F. Similar to the steps discussed above, the heat source system 46 may continue to receive measurement information 74 from the cooking device system 82, thereby allowing the heat source system 46 to check the amount of energy being provided to the cooking device 86. Additionally, the heat source system 46 may also keep track of the amount of time that has elapsed in the current step.

The activities performed by the components of the cooking system 10 (discussed above) may continue for each of the steps of the cooking recipe. Once all of the steps of the cooking recipe have been completed (e.g., when the user indicates in the electronic cookbook 30 that all steps have been completed), the wireless device 14 may transmit final cooking instructions 70 to the heat source system 46. The final cooking instructions 70 may include instructions to the heat source system 46 to shut down all energy being provided to the cooking device 86. Therefore, when all steps of the cooking recipe have been completed, the wireless device 14 may cause the heat source system 46 to automatically shut down the heat source 50, which may prevent the user from having to manually shut off the heat source 50 (or to remember to shut off the heat source 50).

Modifications, additions, and/or substitutions may be made to the cooking system 10, the components of the cooking system 10, and/or the functions of the cooking system 10 without departing from the scope of the specification. For example, the cooking system 10 may include one or more (or all) of the components, functionalities, and/or abilities described (and/or claimed) in U.S. Patent Application Publication No. 2016/0051078 entitled “Automated Cooking Control Via Enhanced Cooking Equipment,” which is incorporated herein by reference.

In addition to the steps described above, in some examples, the cooking system 10 may encounter obstacles when proceeding through the cooking recipe. As one example, the user may move away from the food item being cooked, such as to another room. In doing so, the user may take the wireless device 14 (such as their mobile phone or their tablet) with them. For example, the user may take the wireless device 14 to another room to make a call, to show a family member a video or picture stored on the wireless device 14, to browse the Internet, or to perform any other action with the wireless device 14 (including no action at all, such as when the user just carries the wireless device 14 with them), or any combination of the preceding. This may cause the wireless device 14 to move outside of communication range with the heat source system 46 and/or cooking device system 82, which may cause the first and/or third communication links to fail (at least temporarily).

Such movement away from the food item being cooked may traditionally be problematic. In particular, the user could forget that the food item is being cooked, which could be a fire hazard. Furthermore, it may be disadvantageous for a heat source to turn off every time the user moves away from communication range because the user may only be leaving the food item alone for a small period of time (such as a few seconds or minutes). Also, many food items may be cooked at low heat for long periods of time. If the heat source were to turn off when the user moves away from communication range, the user would be forced to stay within communication during the entire cooking process (which could be 3-4 hours). Contrary to this, however, the cooking system 10 may utilize the second communication link between the heat source system 46 and the cooking device system 82, as is discussed above This second communication link may allow food to continue to be cooked in accordance with the cooking recipe, even if the user and/or wireless device 14 moves out of communication range of the heat source system 46.

As is discussed above, the heat source system 46 may receive cooking instructions 70 from the wireless device 14. These cooking instructions 70 may include a particular cooking temperature and a particular duration of time (such as 375° F. for 10 minutes). Using these cooking instructions 70, the heat source system 46 may provide energy intended to cook the food item at 375° F. for 10 minutes. Additionally, the heat source system 46 may receive measurement information 74 from the cooking device system 82, which may allow the heat source system 46 to check (continuously or periodically) the amount of energy being provided to the cooking device 86 and/or check for errors in the cooking process

If (or when) the wireless device 14 moves outside of communication range with the heat source system 46 and/or cooking device system 82 (such as if the user carries the wireless device 14 to another room to make a phone call or to browse the internet using the wireless device 14), the heat source system 46 may still be able to communicate with the cooking device system 82 using the second communication link. As such, the heat source system 46 may still receive measurement information 74 from the cooking device system 82, thereby allowing the heat source system 46 to continue to check the amount of energy being provided to the cooking device 86 and/or to check for errors in the cooking process. Thus, cooking may continue to proceed in accordance with the cooking instructions 70.

Such operation by the heat source system 46 may continue for any amount of time after the wireless device 14 has moved outside of communication range. In one example, such operation by the heat source system 46 may continue until the duration of time has lapsed. For example, if the cooking instructions 70 indicated that the food item was to be cooked at 375° F. for 10 minutes, the heat source system 46 may continue to cook the food item at 375° F. for the duration of 10 minutes.

If the wireless device 14 were to return to within communication range before the end of the 10 minutes, no change in the cooking process may have occurred because the heat source 50 may have continued to cook the food item at 375° F. in accordance with the cooking instructions 70 (and with the help of the second communication link). Furthermore, no change in the cooking process may occur as long as the user performs the next step.

Alternatively, if the duration of 10 minutes were to lapse before the wireless device 14 was able to move back inside of communication range (such as if the phone call were to run long), the heat source system 46 may determine a next step using the cooking instructions 70. For example, the cooking instructions 70 may include a hold temperature (such as for example 150° F.) and a hold duration (such as, for example, 30 minutes) that may cause the heat source 50 to keep the food item warming (or cooking) at the hold temperature for the hold duration. This may allow the user additional time to bring the wireless device 14 back into communication range without completely ruining (or stopping) the cooking process. If the wireless device 14 does not move back into communication range before the hold duration lapses, the heat source system 46 may shut down the heat source 50, or move to a secondary hold temperature for a secondary duration of time.

As another example, the cooking instructions 70 may include a jump ahead step. As one example of this with regard to a cooking recipe for roasting a chicken, if the steps of the cooking recipe for the roasted chicken are almost all complete (such as if the only step that has not been complete is a minor step of adding a few spices to the chicken before a long roasting period), the jump ahead step may cause the cooking recipe to skip to the last step (or to the next major cooking step), where for example, the chicken is roasted at 375° F. for two hours. This jump ahead step may allow the chicken to be fully roasted (but without a few minor additional ingredients). As such, the entire recipe may not be ruined by the wireless device 14 moving outside of communication range and not returning until after the duration of time has elapsed.

Additionally, if it is determined that the wireless device 14 has moved outside of communication range, the wireless device 14 may attempt to notify a user of this problem. For example, the wireless device 14 may sound an audible alarm, vibrate, change the display screen of the wireless device 14 (such as change the color of the screen to red), text the user, call the user, or provide any other alert to the user. It may also attempt to alert them via an alternative communication mechanism that will be delivered to another device such as a computer or a smart TV. The wireless device 14 may also attempt to automatically fix the communication problem by attempting to establish a different communication link with the heat source system 46 and/or cooking device system 82. For example, if the wireless device 14 is using a Bluetooth communication link when the wireless device 14 moves outside of communication range, the wireless device 14 may attempt to establish a Wi-Fi communication link (or any other WPAN communication link, or an infrared communication link, or a cellular communication link, or any other wireless communication link) with the heat source system 46 and/or cooking device system 82. In such an example, the wireless device 14 may cycle (or scan) through all of (or a portion of) its communication protocols in order to reestablish a communication link. Alternatively (or additionally), the heat source system 46 and/or cooking device system 82 may attempt to reestablish a failed communication link by cycling (or scanning) through all of (or a portion of) their communication protocols in order to reestablish a respective communication link.

Also, the wireless device 14 may also attempt to establish a communication link with an intermediary device that may communicate with the heat source system 46 and/or the cooking device system 82. For example, although the wireless device 14 is out of communication range with the heat source system 46 and/or cooking device system 82, the wireless device 14 may be within communication range (such as Bluetooth communication range) of an intermediary device (such as another mobile phone or another tablet) that is in a communication range (such as Bluetooth communication range) with the heat source system 46 and/or the cooking device system 82. In such an example, the wireless device 14 may use the intermediary device to extend its communication range. Alternatively (or additionally), the heat source system 46 and/or cooking device system 82 may attempt to establish a communication link with an intermediary device that may communicate with the wireless device 14.

FIGS. 9A-9C illustrate an example heat source system having a user interface system. For example, FIG. 9A illustrates a perspective view of an example heat source system having a user interface system; FIG. 9B illustrates a cross-sectional view of the user interface system of the example heat source system taken along section line 9B of FIG. 9A; and FIG. 9C illustrates components of the user interface system of the example heat source system of FIG. 9A. As is illustrated, the heat source system 46 (such as an induction burner system) includes a heat source 50 (such as induction coils). Furthermore, the heat source system 46 also includes a user interface system 56 having light source systems 212 (e.g., light source systems 212a-212j) that may provide a visual representation of an amount of energy being provided by the heat source 50 to a food item. Additionally, the user interface system 56 also includes a touch sensor 224 that may allow a user to input (or otherwise select) an amount of energy to be provided by the heat source 50 to a food item.

The heat source system 46 of FIGS. 9A-9C includes a heat source 50 and a user interface system 56. The heat source system 46 represents any suitable components that can provide an amount of energy to cook a food item (as is discussed above). Furthermore the heat source system 46 may communicate with the wireless device 14 to assist the user in cooking and/or may communicate with the cooking device system 82 to assist the user in cooking (as is discussed above). As is illustrated, the heat source system 46 is an induction burner system.

The heat source 50 of the heat source system 46 may be any device that may provide an amount of energy to cook a food item (as is discussed above also). For example, the heat source 50 may be a burner (such as an induction burner, gas burner, infrared burner, and/or heating coil), a resistive heating element, an induction coil, a resistance heater (i2R), an infrared emitter, a heat lamp (such as halogen lamp) an oven, a microwave, a stovetop, a range, a grill, any other device that may provide an amount of energy to cook a food item, or any combination of the preceding. As is illustrated, the heat source 50 is an induction burner. The heat source system 46 may include any number of heat sources 50.

The user interface system 56 represents any suitable components that allow a user to provide input to the heat source system 46 and/or that allow the heat source system 46 to provide output (such as a visual output) to the user of heat source system 46. As illustrated, the user interface system 56 includes a power button 204, an advance button 208, light source systems 212 (e.g., light source systems 212a-212j), and touch sensor 224.

The power button 204 may be any component that may be activated (or otherwise selected) by a user in order to provide power to the heat source system 46. For example, activating the power button 204 may cause the heat source system 46 to awaken and begin operating. When operating, the heat source system 46 may receive signals from other devices (such as wireless device 14) and/or inputs from a user (such as an input on touch sensor 224). When the heat source system 46 is awakened using the power button 204, the heat source 50 may not automatically begin providing energy. Instead, the heat source 50 may remain off (and not providing energy energy) until the heat source system 46 receives an input from another device (such as cooking instructions 70 from the wireless device 14) or an input from a user (such as an input on the touch sensor 224).

The advance button 208 may be any component that may be activated (or otherwise selected) by a user in order for electronic cookbook 30 to advance to a subsequent step (or stage) in a cooking recipe. For example, the advance button 208 may be an actuatable button or switch that may be activated by the user. By activating the advance button 208, a signal may be transmitted by the heat source system 46 to the wireless device 14 to cause the electronic cookbook 30 to advance to the subsequent step. Additionally, the advance button 208 may further allow the user to indicate any other operation to the electronic cookbook 30, such as “return to a previous step,” “return to the beginning,” “repeat the current step,” “pause the step instructions,” “turn off the video display,” “turn off the audio,” “turn off the heating system,” “switch the display device,” “switch to another heating unit of the heating system,” “switch to instructions for another recipe,” “provide an updated step,” “turn off the auxiliary button,” “modify the auxiliary button sensitivity,” or “refresh the device pairing.”

As is discussed above, the user interface system 56 includes light source systems 212. A light source system 212 may be any device or component that may emit light (or otherwise provide light) for viewing by a user of the heat source system 46. For example, the light source system 212 may emit light in order to provide all or a portion of a visual representation of an amount of energy being provided by heat source 50 of heat source system 46.

The user interface system 56 may include any number of light source systems 212. As illustrated, the user interface system 56 includes ten light source systems 212 (e.g., light source systems 212a-212j). Each of the light source systems 212 may be indicative of (or represent or correspond to) an amount of energy being provided by heat source system 50. For example, each of the light source systems 212 may be indicative of a percentage (such as 10%) of the maximum power (or maximum amount of energy) that may be provided by the heat source 50. In such an example, if the heat source 50 is providing 50% of the maximum power that it is capable of providing, five of the ten light source systems 212 (such as light source systems 212a-212e) may emit light (while the others do not).

If the heat source 50 is providing 95% of the maximum power that it is capable of providing, nine of the ten light source systems 212 (such as light source system 212a-212i) may emit light for a visual representation of 90% of the maximum power, and the tenth light source system 212 (such as light source system 212j) may emit a partial amount of light (and/or may blink on and off, and/or may emit a different colored light) for a visual representation of an extra 5% of the maximum power (for a total visual representation of 95% of the maximum power). As such, the number of light source systems 212 emitting light (and also how that light is emitted) may correspond to the amount of energy being provided by the heat source 50.

Although the light source systems 212 have been described above as being indicative of (or represent or correspond to) a percentage (such as 10%) of the maximum power that may be provided by the heat source 50, the lights source systems 212 may be indicative of (or represent or correspond to) any other measurement or portion of an amount of energy that may be provided by the heat source 50. For example, the light source systems 212 may be indicative of a temperature that may be provided by the heat source 50 (such as each light source system 212 may be indicative of, for example, 50° F.), or the light source systems 212 may be indicative of a percentage of any other amount of power (e.g., a power level different than the maximum power) that may be provided by the heat source 50.

The light source systems 212 may be positioned in any manner with regard to each other. For example, the light source systems 212 may be positioned in a horizontal array, as is illustrated in FIG. 9A. As another example, the light source systems 212 may be positioned in a vertical array. Such arrays may allow the light source systems 212 to provide a visual representation that is easier to view and understand by the user.

As illustrated, a light source system 212 includes a light source 216 and a light pipe 220. The light source 216 represents any device or component that may generate, provide, or emit light. For example, as is illustrated in FIG. 9B, the light source 216 is a light emitting diode. The light source 216 may generate any type of light, any color(s) of light, and/or any amount(s) of light (e.g., any amount (or power) of radiant energy, radiant flux, and/or any other measurement of an amount of light). The light source 216 may also blink on and off at any frequency.

A light source system 212 may include any number of light sources 216. Furthermore, the lights sources 216 of a single light source system 212 may be the same, or may be different. For example, a light source system 212 may include a first light source 216 that emits green light, a second light source 212 that emits red light, and a third light source 216 that emits yellow light.

A light source 216 may be positioned at any location in a light source system 212 and/or at any location with regard to any other component of a light source system 212. For example, as is illustrated in FIG. 9B, light source(s) 216 may be positioned at the bottom of (or underneath) light pipe 220. As another example, light source(s) 216 may be positioned at the top of (or above) light pipe 220, or in-between two successive light pipes 220 (e.g., a light pipe 220 above the light source(s) 216 and another light pipe 220 below the light source(s) 216).

The light pipe 220 represents any device or component that may transport and/or distribute light for the purpose of illumination. In some examples, a light pipe may be an elongated block of transparent material(s) that is optically coupled to a light source at one end, and in which light propagates down the pipe toward the opposing end by a combination of direct transmission and total internal reflection (TIR) off the internal walls of the light pipe. The emission of light from the coupled light source (such as light source 216) may be visible from a side of the light pipe having one of a textured, faceted, or frosted surface that causes a portion of the light impinging on the surface to exceed the critical angle for TIR and hence “leak” from that side, that is escape the pipe to propagate in the direction of the observer. The leakage is preferably gradual and diffuse so the entire length of the light pipe may be visible when illuminated. Light propagating down the center of the light pipe may not leak unless the end is mirrored, and the end is preferably mirrored at an oblique angle with respect to the normal vector to a wall surface.

As is illustrated, the light pipe 220 may be a solid transparent tube that may distribute light generated by a light source 216 along all (or a portion) of the length of the light pipe 220. Such a distribution may cause light to be visible to a user along all (or portion) of the length of the light pipe 212, as is illustrated by emitted light waves 222 in FIG. 9B. In one example, when the light pipe 220 is receiving light, the light may be distributed and viewable as a vertical bar, as is illustrated by each of the vertical bars seen in FIG. 9A.

The light pipe 220 may have any size. For example, the light pipe 220 may have a length of 0.1 inches-2.0 inches and a width of 0.001 inches-0.5 inches. The light pipe 220 may also have any shape. For example, the light pipe 220 may be shaped as a line, a bar, a circle, a square, any other shape, or any combination of the preceding. As another example, the light pipe 220 may be curved, as is illustrated in FIG. 9B. As a result of being curved, most of the light from light source 216 may propagate down the pipe by TIR. The curvature of the light pipe 220 may be designed to correspond with, accentuate, fit, and/or match an external surface shape (or any other shape) of the heat source system 46. As is illustrated in FIG. 9B, the curvature of the light pipe 220 matches the curved external surface shape of the heat source system 46. Furthermore, as is seen in FIG. 9A, the curved bar shape of the light pipe 220 distributes light so as to be viewable as a vertical bar. As such, when all ten light source systems 212 are emitting light, the user may see a vertical representation that includes ten vertical bars situated in a horizontal array.

In some examples, the light pipe 220 may be straight (as opposed to curved). In such an example, the fraction of light propagating by TIR may be increased by including a large divergent angle of the light entering the light pipe 220 from the light source 216 and/or by pointing the center of the light generated by the light source 216 at a wall of the light pipe 220.

The light pipe 220 may further be oriented in any direction. For example, the light pipe 220 may be oriented vertically, horizontally, diagonally, any other direction, or any combination of the preceding. Furthermore, the light pipe 220 may distribute (or transport) emitted light over any portion of the size and/or shape.

The light pipe 220 may be made of (or constructed of) any material that may allow light to be transported or distributed for the purpose of illumination. The light pipe 220 may have a frosted or faceted surface, so as to promote leakage of light.

In some examples, it may be desirable to have a user or observer distinguish between adjacent light pipes 220 in which the light sources 216 have a different luminance or radiance, so as to note that one of the light sources 216 has power at a lower energy than the other. In such examples, a user may best note such distinctions when each light pipe 220 is spaced apart from the adjacent light pipe 220 by at least about the width of the light pipe 220, but more preferably at least about 3 times the width of the light pipe 220, in some examples. Furthermore, a dark background may be provided between adjacent light pipes 220, so as to aid in the user's discrimination of the power levels of adjacent light sources 216, in some examples. Additionally, a light pipe 220 aspect ratio of at least about 5 to 1 or more preferably 10 to 1 may further favor such visual discrimination by a user.

Additionally, the light pipes 220 may be spaced at a distance from each other of 3 to 6 times the light pipe width. This may, in some examples, provide the user with a better means to adjust power levels at intermediate values between the proportional power representation of the light pipe discrete positions. Such spacing may be provided where, for example, the light source systems 212 are superimposed over the touch sensor 224 (such as, for example, when the touch sensor 224 is structurally underneath the light source systems 212, as is illustrated in FIG. 9B and as discussed further below)

As is also discussed above, the user interface system 56 may further include a touch sensor 224. The touch sensor 224 may represent any device and/or component that may allow a user to provide an input to heat source system 46. For example, the touch sensor 224 may be a capacitive touch sensor, a resistive touch sensor, any other touch sensor, any other device and/or component that may allow a user to provide an input to heat source system 46, or any combination of the preceding. As is illustrated, the touch sensor 224 is a capacitive touch sensor that may detect an object that is conductive or that has a different dielectric from that of air (such as a user's finger and/or a capacitive pen).

The touch sensor 224 may be a mutual capacitance touch sensor (e.g., where an object alters the mutual coupling between row and column electrodes, which are scanned or driven sequentially) or a self-capacitance touch sensor (e.g., where the object loads the sensor or increases the parasitic capacitance to ground). When a user touches the capacitive touch sensor 224 (with their finger or with another object), a processor or controller coupled to the touch sensor (such as processor 58 discussed above, or another processor or controller that may communicate with the touch sensor 224 and processor 58) may determine the location of the touch indirectly from the change in the capacitance as measured from the four corners of the touch sensor, for example. In such an example, the larger the change in capacitance, the closer the touch is to that corner of the touch sensor 224. Additionally, in addition to detecting touches, the touch sensor 224 may also detect a near touch (such as the user hovering their finger over a location on the touch sensor 224, but not actually touching the touch sensor 224 or any component in direct or indirect contact with the touch sensor 224). In such an example, the touch sensor 224 may determine the location of the near touch.

The touch sensor 224 may allow a user to provide an input to heat source system 46. For example, the touch sensor 224 may allow a user to input (or otherwise select) an amount of energy to be provided by the heat source 50 of the heat source system 46. A user may utilize the touch sensor 224 in any manner to provide an input to heat source system 46. For example, the user may touch the touch sensor 224 in a particular location, the user may swipe their finger along the surface of the touch sensor 224, the user may draw a symbol on the touch sensor 224, the user may utilize the touch sensor 224 in any other manner to provide an input to heat source system 46, or any combination of the preceding.

In order to allow the user to input an amount of energy to be provided by the heat source 50 of the heat source system 46 (or to provide any other input to the heat source system 46), the touch sensor 224 may associate locations of the touch sensor 224 with an amount of energy. For example, the length of the touch sensor (or any other dimension) of the touch sensor 224 may be broken up into sections that each represent (or are otherwise associated with) an amount of energy that may be selected by the user (e.g., percentage of maximum power, actual temperature, etc.). In an example where a user may input a percentage of the maximum power of the heat source 50, the length of the touch sensor 224 may be divided (such as equal divided) into sections that represent each percentage of the maximum power, from 0%-100%. Therefore, if, for example, the user touches the section of the touch sensor 224 that represents 0% (such as the far left curved end of the touch sensor 224 in FIG. 9A), the touch sensor 224 (and its processor) may associate the touch with a request for 0% of the maximum power, and may adjust the heat source 50 to provide 0% of the maximum power. Additionally, if the user touches the section of the touch sensor 224 that represents 50%, the touch sensor 224 (and its processor) may associate the touch with a request for 50% of the maximum power, and may adjust the heat source 50 to provide 50% of the maximum power.

The sections of the touch sensor 224 may be divided based on the light source systems 212. For example, as is illustrated in FIG. 9A, the user interface system 56 may include ten light source system 212 that each represent, for example, 10% of the maximum power of the heat source 50. In such an example, the sections of the touch sensor 224 may be divided so that a section representing 10% of the maximum power is at (or adjacent) the location of the first light source system 212 (e.g., light source system 212a), a section representing 50% of the maximum power is at (or adjacent) the location of the fifth light source system 212 (e.g., light source system 212e), a section representing 100% of the maximum power is at (or adjacent) the location of the tenth light source system 212 (e.g., light source system 212j), etc. Therefore, if, for example, the user touches the touch sensor 224 at (or adjacent) the fifth light source system 212 (e.g., light source system 212e), the touch sensor 224 (and its processor, such as processor 58 or another processor) may associate the touch with a request for a corresponding 50% of the maximum power, and may adjust the heat source 50 to provide 50% of the maximum power. Also, if the user touches the touch sensor 224 at (or adjacent) the area in-between the seventh and eighth light source systems 212 (e.g., light source systems 212g and 212h), the touch sensor 224 (and its processor) may associate the touch with a request for a corresponding 75% of the maximum power, and may adjust the heat source 50 to provide 75% of the maximum power.

The touch sensor 224 may have any size, shape, and/or orientation. For example, as is illustrated, the touch sensor 224 may be shaped as a horizontal bar. As other examples, the touch sensor 224 may be shaped as a circle, a square, a rectangle, any other shape, or any combination of the preceding. As another example, the touch sensor 224 may further be curved, as is illustrated in FIG. 9B. In such an example (and as is illustrated in FIG. 9B), the curved touch sensor 224 may include a flexible printed circuit board, which may allow the touch sensor 224 to be curved. The curvature of the touch sensor 224 may be designed to correspond with, accentuate, fit, and/or match an external surface shape (or any other shape) of the heat source system 46. As is illustrated in FIG. 9B, the curvature of the touch sensor 224 matches the curved external surface shape of the heat source system 46.

The touch sensor 224 may be positioned at any location with regard to the light source systems 212. For example, the touch sensor 224 may be structurally underneath the light source systems 212, as is illustrated in FIG. 9B. In such an example, the light source systems 212 may cover all (or a portion) of the touch sensor 224. As a result of covering all of the touch sensor 224, a user may be unable to physically touch the touch sensor 224, itself. Instead, the user may touch the light source systems 212 (or other portions covering the touch sensor 224), and the touch sensor 224 may detect a touch when (and where) the user touches a light source system 212 (or another portion covering the touch sensor 224). Furthermore, only a portion of the touch sensor 224 (such as one or more ground planes and/or electrodes) may be structurally underneath the light source systems 212, while the remainder of the touch sensor 224 may be structurally on top of the light source systems 212.

As another example, the touch sensor 224 may be structurally on top of the light source systems 212. In such an example, the touch sensor 224 may be transparent (such as the touch sensor 224 may include an electrode/ground plane that is a transparent conductive coating), which may allow the light source systems 212 to be viewed by the user, despite being structurally underneath the touch sensor 224. Alternatively, the touch sensor 224 may have holes (or openings) cut into it (such as holes cut through the electrode), thereby allowing the light source systems 212 to be viewed through the holes. Furthermore, only a portion of the touch sensor 224 (such as one or more ground planes and/or electrodes) may be structurally on top of the light source systems 212, while the remainder of the touch sensor 224 may be structurally underneath the light source systems 212.

As a further example, the light source systems 212 may be positioned within one or more holes (or openings) cut into the touch sensor 224 (such as holes cut through the electrode). This may allow the light source systems 212 to protrude out of the holes in the touch sensor 224 to create a bump (or other protrusion) that may be felt (or sensed) by a user, such as a user with a visual impairment. Additionally, the light source systems 212 may further include symbols (such as braille symbols) included on the exterior of the light pipes 220, so as to assist a user in identifying each light source system 212. Furthermore, the light source systems 212 may vibrate and/or emit audible sounds when light is being emitted, so as to further assist a user (such as a visually impaired user) in understanding an amount of energy being provided by the heat source 50.

As another example, the light source systems 212 (or the light sources 216 of the light source systems 212) may be positioned on the same printed circuit board (such as printed circuit board 228 of FIGS. 9B-9C) as one or more electrodes (such as one or more sense electrodes) of the touch sensor 224. In such an example, the light pipes 220 may transport the light from the light sources 216 to a position on the user interface system 56 where the light may be viewed by a user.

As is illustrated in FIG. 9A, the light source systems 212 and the touch sensor 224 may be positioned in the user interface system 56 in a manner where it appears that they are the same interface (as is seen in FIG. 9A by the curved bar touch sensor 224 that visually appears to include ten light source systems 212). Alternatively, the light source systems 212 and the touch sensor 224 may be positioned in a manner that causes them to visually appear as separate interfaces. For example, the light source systems 212 may be positioned on the user interface system 56 in a location that is to the left of the touch sensor 224, to the right of the touch sensor 224, vertically above the touch sensor 224, vertically below the touch sensor 224, any other location, or any combination of the preceding. This positioning may cause the light source systems 212 and the touch sensor 224 to be positioned together (such as positioned in a manner where it appears that they are the same interface, as is discussed above), positioned proximal to each other (such as positioned in a manner where it appears that they are different interfaces that are positioned next to each other), or positioned a distance from each other (such as positioned a few inches from each other).

In one example of operation of FIGS. 9A-9C, a user may desire to cook a food item, such as a steak or chili. As is discussed above, for such a food item to be cooked, cooking instructions 70 may be transmitted to the heat source system 46 (such an induction burner system). The cooking instructions 70 may include a particular temperature (such as 375° F.) and a particular duration of time (such as 10 minutes). Based on receiving the cooking instructions 70 (which may include an indication of a 375° F. temperature and an indication of a 10 minute duration of time), the heat source system 46 may activate the heat source 50, so as to begin providing energy to the cooking device 86 of the cooking device system 82. For example, the heat source system 46 (via the processor 58, for example) may increase the amount of energy (or otherwise adjust the amount of energy) being provided by the heat source 50, so as to warm the heat source 50 to a temperature where it cooks the food item at the 375° F.

To warm the heat source 50 to a temperature where it cooks the food item at the 375° F., the heat source system 46 may cause the heat source 50 to initially provide energy at 100% of its maximum power. As the heat source 50 nears the desired 375° F. temperature, the heat source system 46 may reduce the amount of energy being provided by the heat source 50, such as to 75% of the maximum power. When the heat source 50 heats up to the desired 375° F. temperature, the heat source system 46 may further reduce the amount of energy being provided by the heat source 50, such as to 10% of the maximum power, which may allow the heat source 50 to maintain the desired 375° F. temperature.

In addition to increasing the amount of energy (or otherwise adjusting the amount of energy) being provided by the heat source 50, the heat source system 46 may also send to the user interface system 56 an indication of the amount of energy being provided by the heat source 50. For example, the heat source system 46 (via the processor 58, for example) may send to the user interface system 56 an indication of the 100% of the maximum power being provided by the heat source 50. The indication may be data (or other information) that may allow the user interface system 56 (such as a controller positioned on printed circuit board 228 and controlling the light sources 216, for example) to determine the amount of energy being provided by the heat source 50. For example, the indication may be the amount of energy itself (e.g., 100%), or it may be a signal or pointer (or any other type of data) that may be used by the user interface system 56 to determine that amount of energy, or it may be a signal that causes a processor (or controller) of the user interface system 56 to turn on (or turn off) one or more of the light sources 216. Alternatively, when the processor 58 of the heat source system 46 is controlling the light sources 216 of the light source systems 212 (for example), the indication may be a signal that causes the light sources 216 to turn on (or turn off), such as a signal that causes electrical power to be applied to particular light sources 216, causing them to turn on.

Based on the indication of the amount of energy being provided by the heat source 50 (e.g., an indication of the 100% of the maximum power being provided by the heat source 50), the light source systems 112 may emit light, thereby creating a visual representation of the amount of energy being provided by the heat source 50. For example, when the indication is an indication of 100% of the maximum power being provided by the heat source 50, all ten of the light sources systems 212 may emit light (which may be generated by light sources 216 and transported and/or distributed by light pipes 220), thereby visually representing to the user that the heat source 50 is providing energy at 100% of its maximum power.

The visual representation may have any visual form for representing to the user that the heat source 50 is providing energy at 100% of its maximum power. For example, according to the example illustrated in FIG. 9A, the visual representation may include ten illuminated vertical bars situated in a horizontal array. Such a horizontal array may create a horizontal bar graph that is made up of individual vertical bars. This horizontal array may be easier to view and understand by the user.

All of the vertical bars (which are each visually created by a light source system 212) may have the same color. For example, all of the vertical bars may be white. Alternatively, one or more of the vertical bars may be different colors. For example, the first four vertical bars (illustrated as light source systems 212a-212d) may be a first color indicating low power (such as white), the next three vertical bars (illustrated as light source systems 212e-212g) may be a second color indicating medium power (such as yellow), and the last three vertical bars (illustrated as light source systems 212h-212j) may be a third color indicating high power (such as red).

If the heat source 50 takes time to warm up to providing energy at 100% of its maximum power, the warm up time may be visually represented to the user. For example, as the heat source 50 warms up to providing energy at 100% of its maximum power, the number of light source systems 212 emitting light may increase until all light source systems 212 are emitting light. As another example, as the heat source 50 warms up to providing energy at 100% of its maximum power, all of the light source systems 212 may emit light, but they may all emit a particular color of light indicating a warm up stage (such as yellow) until the warm up is complete. After that, the light source systems 212 may change back to emitting their traditional light color (such as white). As a further example, as the heat source 50 warms up to providing energy at 100% of its maximum power, all of the light source systems 212 may emit light, but they may all blink on and off until the warm up is complete. After that, the light source systems 212 may change back to being constantly on (as opposed to blinking). The warm up visual representation provided by the light source systems 212 may be based on a single indication of the amount of energy being provided by the heat source 50, or each change (or one or more of the changes) in the visual representation may be based on different (or separate) indications of the amount of energy being provided by the heat source 50 (e.g., one indication for warming up, another indication for when the warm up is complete).

As is discussed above with regard to the example of the heat source 50 cooking food at a temperature of 375° F., the heat source system 46 may initially cause the heat source 50 to provide energy at 100% of its maximum power. However, as the heat source 50 nears the desired 375° F. temperature, the heat source system 46 may reduce the amount of energy being provided by the heat source 50, such as to 75% of the maximum power. In addition to reducing the amount of energy being provided by the heat source 50, the heat source system 46 may also send to the user interface system 56 an indication of the amount of energy being provided by the heat source 50. For example, the heat source system 46 may send to the user interface system 56 an indication of the 75% maximum power being provided by the heat source 50.

Based on the indication of the amount of energy being provided by the heat source 50 (e.g., an indication of 75% of the maximum power being provided by the heat source 50), the light source systems 112 may emit light, thereby creating a visual representation of the amount of energy being provided by the heat source 50. In the example illustrated in FIG. 9A, such an emission of light by the light source systems 212 may create a visual representation that changes from ten illuminated vertical bars (to represent 100% of the maximum power) to a visual representation that includes seven illuminated vertical bars, and also an eighth vertical bar that is illuminated in a manner that indicates the extra 5% of the maximum power (for a total of 75% of the maximum power).

The extra 5% of the maximum power may be visually represented in any manner. For example, the eighth light source system 212 may emit a partial amount of light (in comparison to each of the other seven light source systems 212). In such an example, the eighth light source system 212 may emit light at 50% of the power of each of the other seven light source systems 212. As such, the vertical bar created by the eighth light source system 212 may be dimmer than the other vertical bars. Furthermore, the amount of power emitted by the eighth light source system 212 may be broken up into fractions, where each fraction represents 1% (or any other percentage).

As a further example, the extra 5% of the maximum power may be visually represented by the eighth light source system 212 emitting a particular color that is different from each of the other seven light source systems 212. In such an example, the eighth light source system 212 may emit a yellow light, while each of the other seven light source systems 212 emit a red light, for example. As such, the vertical bar created by the eighth light source system 212 may be yellow, while the rest of the vertical bars may be red. Furthermore, the shade of color emitted by the eighth light source system 212 may be broken up into fractions, where each fraction represents 1% (or any other percentage). In such an example, the eighth light source system 212 may emit a color that is 1/10^{th} a standard yellow shade to represent 1%, 5/10^{th} a standard yellow shade to represent 5%, 9/10^{th} a standard yellow shade to represent 9%, etc.

As another example, the extra 5% of the maximum power may be visually represented by the eighth light source system 212 blinking on and off. In such an example, the eighth light source system 212 may blink on and off, while each of the other seven light source systems 212 remain unblinking, for example. As such, the vertical bar created by the eighth light source system 212 may blink, while the rest of the vertical bars may remain unblinking. Furthermore, the speed at which the eighth light source system 212 blinks may be broken up into fractions, where each fraction represents 1% (or any other percentage). In such an example, the eighth light source system 212 may blink at a slow speed to represent 1%, a medium speed to represent 5%, and a fast speed to represent 9%, etc. (with each percentage causing the eighth light source system 212 to blink faster (or slower in another example)).

The activities performed by the components of the heat source system 46 and the user interface system 56 (discussed above) may continue for each of the steps of the cooking recipe, such as the cooking recipe for cooking chili (discussed above). In doing so, the visual representation of vertical bars may fluctuate in-between zero vertical bars and all ten vertical bars being displayed to the user, as the amount of energy provided by the heat source 50 fluctuates. Additionally, the activities performed by the components may further include (or take into account) receiving information from measurement sensors 90 (discussed above) and further adjusting the amount of energy provided by the heat source 50 based on measurement information 74 (also discussed above).

This visual representation may provide visual feedback of the cooking process. As such, the user may be able to visually confirm that the cooking process is occurring (such as visually confirm that the heat source system 50 is heating up in accordance with a cooking recipe, for example).

Additionally, the visual representation may also allow a user to visually confirm that one or more communication links (discussed above) are operating properly. For example, the visual representation may indicate to the user that the heat source 50 is heating up in accordance with the cooking recipe. In such an example, the user may be able to confirm that the wireless device 14 is properly transmitting cooking instructions 70 to the heat source system 46 using the first communication link (discussed above).

The visual representation may also allow a user to visually confirm when a cooking step (or stage) is complete or near complete (e.g., it may provide advance warning of the step's near completion). For example, a particular step of a cooking recipe may instruct the user to add one cup of tomato sauce to the food item (such as chili) and then heat the chili to a boil. In such an example, the heat source system 46 may automatically determine (using measurement sensors 90, for example) that the cup of tomato sauce has been added to the food item. Based on such an automatic determination, the heat source system 46 may further automatically increase the amount of energy being provided by the heat source 50, so as to bring the chili to a boil. When the user interface system 56 provides a visual representation of the increase in energy being provided by the heat source 50, the user may be able to confirm (or otherwise determine) that the user has properly added the cup of tomato sauce, and that the step is now being completed (e.g., heat to boil) by the heat source system 46.

The visual representation may also allow a user to visually confirm when cooking is complete (e.g., no vertical bars are being displayed), when cooking has reached a control point, and/or when food is being held warm after cooking (e.g., only one vertical bar is being displayed).

Once all of the steps of the cooking recipe have been completed (e.g., when the user indicates in the electronic cookbook 30 that all steps have been completed), the wireless device 14 may transmit final cooking instructions 70 to the heat source system 46. The final cooking instructions 70 may include instructions to the heat source system 46 to shut down all energy being provided to the cooking device 86. Based on this, the heat source system 46 may automatically shut down the heat source 50 (causing the heat source 50 to no longer provide energy). Furthermore, the heat source system 46 may additionally transmit an indication of this amount of energy (e.g., no energy) to the user interface system 56. Based on this, the light source systems 112 may stop emitting light, which in the example illustrated in FIG. 9A may cause zero vertical bars to be displayed to the user.

In addition to the steps described above, in some examples, the user may want to manually adjust the amount of energy being provided by the heat source 50. For example, the user may want to adjust or change the cooking temperature recommended in the cooking recipe and provided in the cooking instructions 70. In such an example, the recipe may recommend browning meat at 375° F., but the user may desire to brown the meat at a different temperature, such as 425° F. As another example, the user may be cooking a food item without an electronic cookbook 30 to provide cooking instructions 70 to the heat source system 46 (e.g., the user may be cooking using a cooking recipe they found in a book or that they know by memory). In such an example, all (or a portion) of the cooking may need to be done using manual adjustments of the heat source 50.

To provide such a manual adjustment, the user may touch the touch sensor 224 at a position on the touch sensor 224 that is associated with the amount of energy the user wants the heat source 50 to provide. For example, as is discussed above, the touch sensor 224 may associate locations of the touch sensor 224 with an amount of energy. Therefore, if, for example, the user touches the touch sensor 224 at (or adjacent) the fifth light source system 212 (e.g., light source system 212e), the touch sensor 224 (and its processor) may associate the touch with a request for 50% of the maximum power. Also, if the user touches the touch sensor 224 at (or adjacent) the area in-between the seventh and eighth light source systems 212 (e.g., light source systems 212g and 212h), the touch sensor 224 (and its processor) may associate the touch with a request for 75% of the maximum power.

A user may utilize the touch sensor 224 in any manner to provide an input to heat source system 46. For example, the user may touch the touch sensor 224 in a particular location, such as at (or adjacent) a particular light source system (such as the third light source system 212c to indicate a desire for 30% of the maximum power). As another example, the user may double touch (or double click) the touch sensor 224 in a particular location. Such a double click may indicate the user's desire for a change in the amount of energy being provided by the heat source 50, but may prevent accidental changes in the amount of energy from being caused by accidental (or incidental) touching of the touch sensor 224.

As another example, the user may swipe their finger along the surface of the touch sensor 224. In such an example, the input received (and acted upon) by the heat source system 46 may be based on the position on the touch sensor 224 at which the user stops the swiping motion. For example, if the swipe starts at the third light source system 212, and ends at the sixth light source system 212, the heat source system 46 may determine the touch to be a request for the power amount associated with the last touch at the sixth light source system 212 (e.g., a request for 60% of the maximum power).

As a further example, the user may draw a symbol on the touch sensor 224. In such an example, the user may draw a “L” for low power, a “M” for medium power, a “H” for high power, any other symbol, or any combination of the preceding. Furthermore, the user may draw a temperature that the user wishes the food item to be cooked at. For example, the user may draw out “375” when the user wishes the food item to be cooked at 375° F.

Following the input by the user, the touch sensor 224 may transmit an indication of the input to the processor 58 of the heat source system 46. The indication may be data (or other information) that may allow the processor 58 to determine the user's input regarding a desired amount of energy to be provided by the heat source 50. For example, the indication may be the change in capacitance (itself) detected by the touch sensor 224, or it may be a signal or pointer (or any other type of data) that may be used by the processor 58 to determine the change in capacitance detected by the touch sensor 224. In such an example, the processor 58 may use the indication to determine where the user touched the touch screen 224, determine the amount of energy that is associated with the user's touch (e.g., the user's desired amount of energy), and may adjust the amount of energy provided by the heat source 50 to the user's desired amount of energy.

As another example, the indication may be the identity of the location that the user touched on the touch screen 224 (or the amount of energy associated with the detected touch) (itself), or it may be a signal or pointer (or any other type of data) that may be used by the processor 58 to determine the identity of the location that the user touched on the touch screen 224 (or the amount of energy associated with the detected touch). In such an example, the touch sensor 224 may include its own controller (or processor) that determines the indication and transmits it to the processor 58. Furthermore, in such an example, the processor 58 may use this indication to determine the amount of energy that is associated with the user's touch (e.g., the user's desired amount of energy), and may adjust the amount of energy provided by the heat source 50 to the user's desired amount of energy.

Following receipt of the indication, the processor 58 may adjust the amount of energy provided by the heat source 50. For example, if the user utilized the touch sensor 224 to input that the heat source 50 is to provide energy at an amount that is 70% of its maximum power, the heat source system 46 (using the processor 58) may adjust the amount of energy provided by the heat source 50 to be 70% of its maximum power. In addition to adjusting the amount of energy being provided by the heat source 50, the heat source system 46 may also send to the user interface system 56 an indication of the amount of energy being provided by the heat source 50. For example, the heat source system 46 may send to the user interface system 56 an indication of 70% of the maximum power being provided by the heat source 50. The indication may be data (or other information) that may allow the user interface system 56 (such as a controller or a processor of the user interface system 56, for example) to determine the amount of energy being provided by the heat source 50. For example, the indication may be the amount of energy itself (e.g., 70% of the maximum power or 375° F.), or it may be a signal or pointer (or any other type of data) that may be used by the user interface system 56 to determine the amount of energy being provided by the heat source 50. As another example, the indication may be one or more signals to the user interface system 56 (such as a controller or a processor of the user interface system 56, for example) to turn on a particular amount (such as a subset) of light source systems 212 (or otherwise cause a particular amount of light source systems 212). As a further example, if the processor 58 is controlling the light sources 216, the indication may be one or more signals that turn on a particular amount (such as a subset) of light source systems 212 (or otherwise cause a particular amount of light source systems 212).

Based on the indication of the amount of energy being provided by the heat source 50 (e.g., an indication of 70% of the maximum power being provided by the heat source 50), the light source systems 112 may emit light, thereby creating a visual representation of the amount of energy being provided by the heat source 50.

The activities performed by the components of the heat source system 46 and the user interface system 56 (discussed above) may continue for each of the steps of the cooking process, such as additional manual inputs of an amount of energy to be provided by the heat source 50. In doing so, the visual representation of vertical bars may fluctuate in-between zero vertical bars and all ten vertical bars being displayed to the user, as the amount of energy provided by the heat source 50 fluctuates. Furthermore, although the activities have been described above with regard to a manual input of an amount of energy, one or more additional steps of the cooking process may proceed using automated cooking steps, such as using cooking instructions 70 from wireless device 14. Additionally, the activities performed by the components may further include (or take into account) receiving information from measurement sensors 90 (discussed above) and further adjusting the amount of energy provided by the heat source 90 based on measurement information 74 (also discussed above).

Although the heat source system 46 has been described above as only having one user interface system 56, the heat source system 46 may have any number of user interface systems 56, and each user interface system 56 may be used with any number of heat sources 50 of the heat source system 46. For example, when the heat source system 46 includes more than one heat source 50 (such as a stovetop that includes two or more gas burners), the heat source system 46 may have multiple user interface system 56, with each user interface system 56 being used for two or more heat sources 50 (e.g., two user interface systems 56 and four heat sources 50, four user interface systems 56 and four heat sources 50, etc.). Alternatively, the heat source system 46 may have a single user interface system 56, which may be used with all of the heat sources 50 (e.g., one user interface system 56 and four heat sources 50).

Modifications, additions, and/or substitutions may be made to the heat source system 46 (and/or the user interface system 56), the components of the heat source system 46 (and/or the user interface system 56), and/or the functions of the heat source system 46 (and/or the user interface system 56) without departing from the scope of the specification. Additionally, the heat source system 46 (and/or the user interface system 56) may include (or function with) one or more (or all) of the components, functionalities, and/or abilities described and/or referenced herein with regard to FIGS. 1A-9C.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A system, comprising:
a. a wireless device having a processor that is operable, when executed, to:
i. display at least a portion of a cooking recipe; and
ii. establish a first communication link with a heat source system to be used to cook a food item in accordance with the cooking recipe;
b. the heat source system, comprising:
i. a heat source operable to provide an amount of energy to be used to cook the food item in accordance with the cooking recipe; and
ii. a processor communicatively coupled to the heat source, and operable, when executed, to:
1. establish a second communication link with a cooking device system;
2. receive, via the first communication link with the wireless device, an indication of a first temperature associated with the cooking recipe;
3. receive, via the second communication link with the cooking device system, an indication of a current temperature associated with the food item; and
4. based on the indication of the first temperature and the indication of the current temperature, adjust the amount of energy provided by the heat source; and
c. the cooking device system, comprising:
i. a cooking device operable to be used in cooking the food item in accordance with the cooking recipe;
ii. one or more temperature sensors coupled to the cooking device and operable to provide a measurement of the current temperature associated with the food item; and
iii. a processor communicatively coupled to the one or more temperature sensors, and operable, when executed, to communicate the indication of the current temperature associated with the food item for reception by the heat source system via the second communication link.

2. The system of claim 1, wherein the processor of the heat source system is further operable, when executed, to:
a. receive, via the first communication link with the wireless device, an indication of a duration of time associated with the first temperature;
b. determine whether the first communication link with the wireless device has failed; and
c. in response to the determination that the first communication link with the wireless device has failed:
i. determine whether the duration of time associated with the first temperature has lapsed;
ii. in response to the determination that the duration of time associated with the first temperature has not lapsed, continue to allow the heat source to provide the adjusted amount of energy.

3. The system of claim 2, wherein the processor of the heat source system is further operable, when executed, to:
a. receive, via the first communication link with the wireless device, an indication of a hold temperature; and
b. in response to the determination that the duration of time associated with the first temperature has lapsed, further adjust the amount of energy provided by the heat source based on the hold temperature.

4. The system of claim 1, wherein the processor of the wireless device is further operable, when executed, to:
a. establish a third communication link with the cooking device system;
b. receive, via the third communication link with the cooking device system, the indication of the current temperature associated with the food item; and
c. display a graphical representation of the current temperature associated with the food item.

5. A system, comprising:
a. a heat source operable to provide an amount of energy to be used to cook a food item; and
b. a processor communicatively coupled to the heat source, and operable, when executed, to:
i. establish a first communication link with a wireless device having a cooking recipe for the food item;
ii. receive, via the first communication link with the wireless device, an indication of a first temperature associated with the cooking recipe;
iii. establish a second communication link with a cooking device system operable to be used in cooking the food item;
iv. receive, via the second communication link with the cooking device system, an indication of a current temperature associated with the food item; and
v. based on the indication of the first temperature and the indication of the current temperature, adjust the amount of energy provided by the heat source.

6. The system of claim 5, wherein the processor is further operable, when executed, to:
a. receive, via the first communication link with the wireless device, an indication of a duration of time associated with the first temperature;
b. determine whether the first communication link with the wireless device has failed; and
c. in response to the determination that the first communication link with the wireless device has failed:
i. determine whether the duration of time associated with the first temperature has lapsed;
ii. in response to the determination that the duration of time associated with the first temperature has not lapsed, continue to allow the heat source to provide the adjusted amount of energy.

7. The system of claim 6, wherein the processor is further operable, when executed, to:
a. receive, via the first communication link with the wireless device, an indication of a hold temperature; and
b. in response to the determination that the duration of time associated with the first temperature has lapsed, further adjust the amount of energy provided by the heat source based on the hold temperature.

8. The system of claim 6, wherein the processor is further operable, when executed, to:
a. in further response to the determination that the first communication link with the wireless device has failed, scan through one or more additional communication protocols in order to attempt to reestablish the first communication link.

9. The system of claim 5, wherein the processor is further operable, when executed, to:
a. receive, via the first communication link with the wireless device, an indication of a duration of time associated with the first temperature;
b. receive, via the first communication link with the wireless device, an indication of a second temperature associated with the cooking recipe;
c. receive, via the second communication link with the cooking device system, an indication of a subsequent current temperature associated with the food item;
d. determine whether the duration of time associated with the first temperature has lapsed; and
e. in response to the determination that the duration of time associated with the first temperature has lapsed, further adjust the amount of energy provided by the heat source based on the indication of the second temperature and the indication of the subsequent current temperature.

10. The system of claim 5, wherein the processor is further operable, when executed, to:
a. receive, via the second communication link with the cooking device system, an advertisement packet from the cooking device system;
b. following the reception of the advertisement packet, transmit, via the second communication link with the cooking device system, a request for additional information from the cooking device system; and
c. following the transmittal of the request for additional information, receive, via the second communication link with the cooking device system, a scan response packet from the cooking device system, wherein the scan response packet includes the indication of the current temperature associated with the food item.

11. The system of claim 5, wherein the processor is further operable, when executed, to:
a. receive, via the first communication link with the wireless device, a unique identifier for the cooking device system; and
b. establish the second communication link with the cooking device system based on the unique identifier for the cooking device system received from the wireless device.

12. The system of claim 5, wherein the cooking device system comprises a cooking device, wherein the cooking device is a cooking pot, a cooking pan, a cooking tray, or a cooking utensil.

13. A method, comprising:
a. establishing, by a processor communicatively coupled to a heat source, a first communication link with a wireless device having a cooking recipe for a food item, wherein the heat source is operable to provide an amount of energy to be used to cook the food item;
b. receiving, by the processor and via the first communication link with the wireless device, an indication of a first temperature associated with the cooking recipe;
c. establishing, by the processor, a second communication link with a cooking device system operable to be used in cooking the food item;
d. receiving, by the processor and via the second communication link with the cooking device system, an indication of a current temperature associated with the food item; and
e. based on the indication of the first temperature and the indication of the current temperature, adjusting, by the processor, the amount of energy provided by the heat source.

14. The method of claim 13, further comprising:
a. receiving, by the processor and via the first communication link with the wireless device, an indication of a duration of time associated with the first temperature;
b. determining, by the processor, whether the first communication link with the wireless device has failed; and
c. in response to the determination that the first communication link with the wireless device has failed:
i. determining, by the processor, whether the duration of time associated with the first temperature has lapsed; and
ii. in response to the determination that the duration of time associated with the first temperature has not lapsed, continuing, by the processor, to allow the heat source to provide the adjusted amount of energy.

15. The method of claim 14, further comprising:
a. receiving, by the processor and via the first communication link with the wireless device, an indication of a hold temperature; and
b. in response to the determination that the duration of time associated with the first temperature has lapsed, further adjusting, by the processor, the amount of energy provided by the heat source based on the hold temperature.

16. The method of claim 14, further comprising:
a. in further response to the determination that the first communication link with the wireless device has failed, scanning, by the processor, through one or more additional communication protocols in order to attempt to reestablish the first communication link.

17. The method of claim 13, further comprising:
a. receiving, by the processor and via the first communication link with the wireless device, an indication of a duration of time associated with the first temperature;
b. receiving, by the processor and via the first communication link with the wireless device, an indication of a second temperature associated with the cooking recipe;
c. receiving, by the processor and via the second communication link with the cooking device system, an indication of a subsequent current temperature associated with the food item;
d. determining, by the processor, whether the duration of time associated with the first temperature has lapsed; and
e. in response to the determination that the duration of time associated with the first temperature has lapsed, further adjusting, by the processor, the amount of energy provided by the heat source based on the indication of the second temperature and the indication of the subsequent current temperature.

18. The method of claim 13, further comprising:
a. receiving, by the processor and via the second communication link with the cooking device system, an advertisement packet from the cooking device system;
b. following the reception of the advertisement packet, transmitting, by the processor and via the second communication link with the cooking device system, a request for additional information from the cooking device system; and
c. following the transmittal of the request for additional information, receiving, by the processor and via the second communication link with the cooking device system, a scan response packet from the cooking device system, wherein the scan response packet includes the indication of the current temperature associated with the food item.

19. The method of claim 13, further comprising:
a. receiving, by the processor and via the first communication link with the wireless device, a unique identifier for the cooking device system; and
b. establishing, by the processor, the second communication link with the cooking device system based on the unique identifier for the cooking device system received from the wireless device.

20. The method of claim 13, wherein the cooking device system comprises a cooking device, wherein the cooking device is a cooking pot, a cooking pan, a cooking tray, or a cooking utensil.

21. A wireless device comprising:
a. a processor that is operable, when executed, to:
i. display at least a portion of a cooking recipe;
ii. establish a first communication link with a heat source system to be used to cook a food item in accordance with the cooking recipe;
iii. transmit, via the first communication link, one or more cooking instructions to the heat source system, wherein the one or more cooking instructions are configured to cause the heat source system to adjust an amount of energy provided by a heat source of the heat source system to cook the food item;
iv. establish a second communication link with a cooking device system, the cooking device system having a cooking device operable to be used in cooking the food item in accordance with the cooking recipe, and further having one or more temperature sensors coupled to the cooking device and operable to provide a measurement of a current temperature associated with the food item;
v. receive a unique identifier associated with the cooking device system via the second communication link, or a unique identifier associated with the heat source system via the first communication link; and
vi. transmit the unique identifier associated with the cooking device system to the heat source system via the first communication link, or the unique identifier associated with the heat source system to the cooking device system via the second communication link; and
vii. wherein the heat source system is operable to establish a third communication link with the cooking device system using the unique identifier associated with the cooking device system, or wherein the cooking device system is operable to establish the third communication link with the heat source system using the unique identifier associated with the heat source system.

22. The wireless device of claim 21, wherein the processor is further operable, when executed, to:
a. determine whether the first communication link with the heat source system has failed; and
b. in response to the determination that the first communication link with the heat source system has failed, scan through one or more additional communication protocols in order to attempt to reestablish the first communication link.

23. A system comprising:
a. a cooking device operable to be used in cooking a food item in accordance with a cooking recipe;
b. one or more temperature sensors coupled to the cooking device and operable to provide a measurement of the current temperature associated with the food item; and
c. a processor communicatively coupled to the one or more temperature sensors, and operable, when executed, to:
i. establish a first communication link with a wireless device that is operable to display at least a portion of the cooking recipe;
ii. establish a second communication link with a heat source system having a heat source operable to provide an amount of energy to be used to cook the food item in accordance with the cooking recipe; and
iii. transmit, via the second communication link, an indication of the current temperature associated with the food item for reception by the heat source system, wherein the indication of the current temperature is configured to cause the heat source system to adjust an amount of energy provided by the heat source of the heat source system to the food item when the current temperature associated with the food item is different from a temperature included in the cooking recipe.

24. The system of claim 23, wherein the processor is further operable, when executed, to:
a. insert the indication of the current temperature associated with the food item into a scan response packet; and
b. transmit the scan response packet for reception by the heat source system.

25. The system of claim 24, wherein the processor is further operable, when executed, to insert the indication of the current temperature associated with the food item into a manufacturer-specific advertising data field of the scan response packet.

26. The system of claim 23, wherein the processor is further operable, when executed to:
a. insert an indication of a subsequent current temperature associated with the food item into a subsequent scan response packet, wherein the indication of the subsequent current temperature associated with the food is different than the indication of the current temperature associated with the food; and
b. transmit the subsequent scan response packet for reception by the heat source system.

27. The system of claim 23, wherein the processor is further operable, when executed, to transmit, via the first communication link, the indication of the current temperature associated with the food item for reception by the wireless device.

28. The system of claim 23, wherein the cooking device is a cooking pot, a cooking pan, a cooking tray, or a cooking utensil.

29. The system of claim 23, wherein the cooking device is a spoon, tongs, a spatula, or a measurement probe.

30. The system of claim 23, wherein the processor is positioned on or in a handle of the cooking device.

31. The system of claim 23, further comprising one or more additional sensors coupled to the cooking device and operable to provide a measurement of current additional information associated with the food item, wherein the current additional information comprises the current volume associated with the food item, the current weight associated with the food item, the current moisture associated with the food item, the current liquid level associated with the food item, or the current pressure associated with the food item.

32. The system of claim 31, wherein the processor is further operable, when executed, to:
a. insert the indication of the current temperature associated with the food item into a scan response packet;
b. insert an indication of the current additional information associated with the food item into the scan response packet; and
c. transmit the scan response packet for reception by the heat source system.

33. The system of claim 31, wherein the processor is further operable, when executed, to transmit, via the first communication link, an indication of the current additional information associated with the food item for reception by the wireless device.
